(19) United States
(12) Patent Application Publication
(10) Pub. No.: US 2024/0114480 A1
(43) Pub. Date: Apr. 4, 2024

(54) CROSS-LINK INTERFERENCE (CLI)-AIDED HYBRID NETWORK POSITIONING

(71) Applicant: QUALCOMM Incorporated, San Diego, CA (US)

(72) Inventors: Weimin DUAN, San Diego, CA (US); Yuwei REN, Beijing (CN); Huilin XU, Temecula, CA (US)

(21) Appl. No.: 18/552,392

(22) PCT Filed: May 25, 2021
(86) PCT No.: PCT/CN2021/095684

§ 371 Date: Sep. 25, 2023

(51) Int. Cl. H04W 64/00; H04L 5/00; H04L 5/14

(52) U.S. Cl. CPC H04W 64/00; H04L 5/0048; H04L 5/14

(57) ABSTRACT

A determination of a position of a target mobile device in a wireless communication network employing time-division duplexing (TDD) can use a wireless reference signal from another mobile device with a known position. The other mobile device can be configured to transmit the wireless reference signal using cross-link interference (CLI), where the target mobile device receives the signal during a period in which the target mobile device is configured to receive downlink (DL) communication. The target mobile device then transmits another wireless reference signal, which is received by a base station, which also receives the wireless reference signal from the other mobile device. The timing of these various signals received at the target mobile device and base station can be used to determine the location of the mobile device.

### BACKGROUND

### 1. Field of Disclosure

The present disclosure relates generally to the field of wireless communications, and more specifically to determining the location (or position) of a User Equipment (UE) using radio frequency (RF) signals.

### 2. Description of Related Art

In a data communication network, various positioning techniques can be used to determine the position of a mobile device (also referred to herein as a user equipment or a UE). Some of these positioning techniques may involve determining distance and/or angular information of RF signals transmitted by one or more base stations of the data communication network. These determinations, however, often involve the use of many base stations and can consume processing resources, time, and power. Such positioning can be particularly burdensome for mobile devices having a low power budget.

### BRIEF SUMMARY

Embodiments described herein provide a low-power solution for determining the position of a target mobile device in a wireless communication network that utilizes time-division duplexing (TDD) by leveraging a wireless reference signal from another mobile device with a known position. In particular, the other mobile device can be configured to transmit the wireless reference signal using cross-link interference (CLI) in which the signal is received by the target mobile device during a period in which the target mobile device is configured to receive downlink (DL) communication from a base station. The target mobile device then transmits another wireless reference signal, which is received by a base station, which also receives the wireless reference signal from the other mobile device. The timing of these various signals received at the target mobile device and base station can be used to determine the location of the mobile device. This determination can be made by the mobile device, base station, or a location server, depending on desired functionality.

An example method of determining a position of a first mobile device, according to this disclosure, comprises obtaining a first time difference, wherein the first time difference comprises a time difference between a time a first wireless reference signal transmitted by a second mobile device arrives at the first mobile device and time the first mobile device transmits a second wireless reference signal, wherein: the first mobile device and the second mobile device are communicatively linked to a wireless communication network employing time-division duplexing (TDD), and the first wireless reference signal comprises a cross-link interference (CLI) transmission, such that the first wireless reference signal arrives at the first mobile device at a time during which the first mobile device is configured to receive downlink (DL) transmissions from a network entity. The method also comprises obtaining a second time difference, wherein the second time difference comprises a time difference between: a time the first wireless reference signal arrives at a base station of the wireless communication network, and a time the second wireless reference signal arrives at the base station. The method also comprises determining the position of the first mobile device based on the first time difference and the second time difference. The method also comprises providing the position of the first mobile device.

An example network-connected device for determining a position of a first mobile device, according to this disclosure, comprises a transceiver, a memory, one or more processors communicatively coupled with the transceiver and the memory, wherein the one or more processors are configured to obtain a first time difference, wherein the first time difference comprises a time difference between: a time a first wireless reference signal transmitted by a second mobile device arrives at the first mobile device and a time the first mobile device transmits a second wireless reference signal, wherein: the first mobile device and the second mobile device are communicatively linked to a wireless communication network employing time-division duplexing (TDD), and the first wireless reference signal comprises a cross-link interference (CLI) transmission, such that the first wireless reference signal arrives at the first mobile device at a time during which the first mobile device is configured to receive downlink (DL) transmissions from a network entity. The one or more processing units are further configured to obtain a second time difference, wherein the second time difference comprises a time difference between: a time the first wireless reference signal arrives at a base station of the wireless communication network, and a time the second wireless reference signal arrives at the base station. The one or more processing units are further configured to determine the position of the first mobile device based on the first time difference and the second time difference. The one or more processing units are further configured to provide the position of the first mobile device.

An example apparatus for determining a position of a first mobile device, according to this disclosure, comprises means for obtaining a first time difference, wherein the first time difference comprises a time difference between: a time a first wireless reference signal transmitted by a second mobile device arrives at the first mobile device and a time the first mobile device transmits a second wireless reference signal, wherein: the first mobile device and the second mobile device are communicatively linked to a wireless communication network employing time-division duplexing (TDD), and the first wireless reference signal comprises a cross-link interference (CLI) transmission, such that the first wireless reference signal arrives at the first mobile device at a time during which the first mobile device is configured to receive downlink (DL) transmissions from a network entity. The apparatus further comprises means for obtaining a second time difference, wherein the second time difference comprises a time difference between: a time the first wireless reference signal arrives at a base station of the wireless communication network, and a time the second wireless reference signal arrives at the base station. The apparatus further comprises means for determining the position of the first mobile device based on the first time difference and the second time difference. The apparatus further comprises means for providing the position of the first mobile device.

According to this disclosure, an example non-transitory computer-readable medium stores instructions for determining a position of a first mobile device, the instructions comprising code for obtaining a first time difference, wherein the first time difference comprises a time difference between a time a first wireless reference signal transmitted by a second mobile device arrives at the first mobile device and a time the first mobile device transmits a second wireless reference signal, wherein: the first mobile device and the second mobile device are communicatively linked to a wireless communication network employing time-division duplexing (TDD), and the first wireless reference signal comprises a cross-link interference (CLI) transmission, such that the first wireless reference signal arrives at the first mobile device at a time during which the first mobile device is configured to receive downlink (DL) transmissions from a network entity. The instructions further comprise code for obtaining a second time difference, wherein the second time difference comprises a time difference between: a time the first wireless reference signal arrives at a base station of the wireless communication network, and a time the second wireless reference signal arrives at the base station. The instructions further comprise code for determining the position of the first mobile device based on the first time difference and the second time difference. The instructions further comprise code for providing the position of the first mobile device.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a diagram showing an example of a frame structure for NR and associated terminology.

FIG. 4 is a diagram that illustrates an example of Cross-Link Interference (CLI).

FIG. 5 is a simplified diagram illustrating how a CLI-aided hybrid network position determination of a target user equipment (UE) 510 may be made using a single base station, according to an embodiment.

FIG. 6 is a time-distance diagram illustrating how timing can be used in the configuration shown in FIG. 5, according to an embodiment.

FIGS. 7-9 are call flow diagrams illustrating embodiments of a process of CLI-aided hybrid network positioning of a mobile device.

FIG. 10 is a simplified diagram illustrating an example variation to the configuration illustrated in FIG. 5, which may be used according to an embodiment.

FIG. 11 is a flow diagram of a method of determining the position of a first mobile device, according to an embodiment.

FIG. 12 is a block diagram of an embodiment of an example mobile device, which can be utilized in embodiments as described herein.

FIG. 13 is a block diagram of an embodiment of an example base station, which can be utilized in embodiments as described herein.

FIG. 14 is a block diagram of an embodiment of an example computer system, which can be utilized in embodiments as described herein.

Like reference symbols in the various drawings indicate like elements, in accordance with certain example implementations.

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

Additionally, references to “reference signals,” “positioning reference signals,” “reference signals for positioning,” and the like may be used to refer to signals used for positioning of a mobile device (again, also referred to herein as a user equipment (UE)). As described in more detail herein, such signals may comprise any of a variety of signal types but may not necessarily be limited to a Positioning Reference Signal (PRS) or Sounding Reference Signal (SRS) as defined in relevant wireless standards.

As previously noted, in data communication network (e.g., a broadband wireless network, cellular phone network, etc.), various positioning techniques can be used to determine the position of a mobile device or UE. These positioning techniques often involve determining distance and/or angular information of wireless reference signals received transmitted by one or more base stations of the data communication network. These determinations, however, often involve the use of many base stations and can consume processing resources, time, and power. Where multiple base stations our involve, for example, the mobile device may need to sample several reference signals transmitted by several base stations. Where a single base station is involved, and Angle of Departure (AoD) measurement may be taken, in which case the mobile device may need to sample signals transmitted on multiple beams (e.g., up to 64 different beams). This amount of sampling can consume a relatively large amount of power for a mobile device. This is especially true for smaller mobile devices, such as mobile phones, wearable devices (smartwatches, smart glasses, etc.), and the like.

As described in further detail below, embodiments herein provide for the determination of a position of a target mobile device by using a wireless reference signal from another mobile device that transmits the wireless reference signal using cross-link interference (CLI). The target mobile device then transmits another wireless reference signal, which is received by a base station, which also receives the wireless reference signal from the other mobile device. As described in further detail hereafter, timing of these various signals received at the target mobile device and base station can be used, along with the positions of the base station and other mobile device, to determine the position of the mobile device. According to some embodiments, the position of the mobile device may further be determined based on measurements of angles of the wireless reference signals received at the base station. Additionally or alternatively, the position may be further based on trilateration, using additional mobile devices in a manner similar to the other mobile device. According to some embodiments, some or all of the reference signals used may comprise signals that may be used for communications. This can allow for positioning of the target mobile device with few or no additional signals required for transmission, thereby reducing any impact the positioning may have on the power usage of the mobile devices. Additional details will follow, after an initial description of relevant systems and technologies.

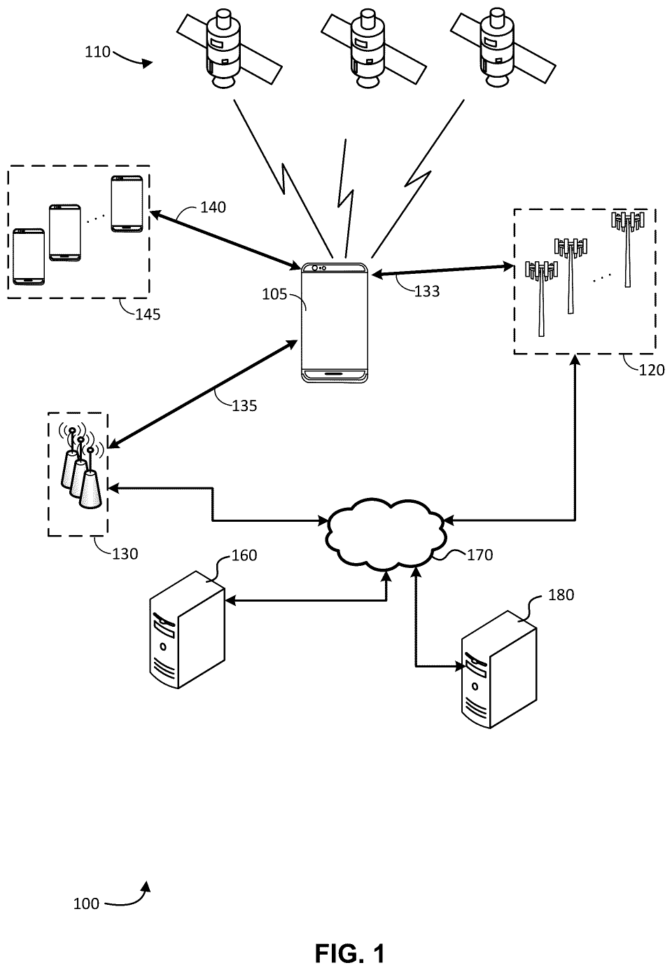

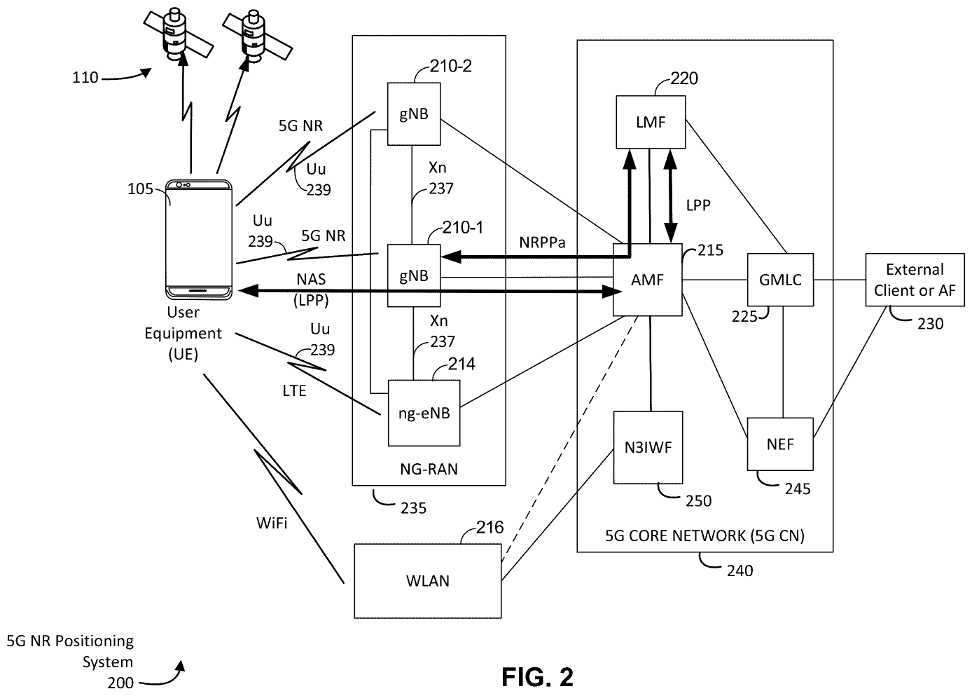

FIG. 1 is a simplified illustration of a positioning system 100 in which a mobile device 1200, location server 160, and/or other components of the positioning system 100 can use the techniques provided herein for CLI-aided hybrid network positioning, according to an embodiment. The techniques described herein may be implemented by one or more components of the positioning system 100. The positioning system 100 can include: a mobile device 1200; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the mobile device 1200 based on RF signals received by and/or sent from the mobile device 1200 and known locations of other components (e.g., GNSS satellites 110, base stations 120, APs 130) transmitting and/or receiving the RF signals. Additional details regarding particular location estimation techniques are discussed in more detail with regard to FIG. 2.

It should be noted that FIG. 1 provides only a generalized illustration of various components, any or all of which may be utilized as appropriate, and each of which may be duplicated as necessary. Specifically, although only one mobile device 1200 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 are communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP, for example. Thus, mobile device 1200 can send and receive information with network-connected devices, such as location server 160, by accessing the network 170 via a base station 120 using a first communication link 133. Additionally or alternatively, because APs 130 also may be communicatively coupled with the network 170, mobile device 1200 may communicate with network-connected and Internet-connected devices, including location server 160, using a second communication link 135.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120 and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 1200 and/or provide data (e.g., “assistance data”) to mobile device 1200 to facilitate location measurement and/or location determination by mobile device 1200. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 1200 based on subscription information for mobile device 1200 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 1200 using a control plane (CP) location solution for LTE radio access by mobile device 1200. The location server 160 may further comprise a Location Management Function (LMF) that supports location of mobile device 1200 using a control plane (CP) location solution for NR or LTE radio access by mobile device 1200.

In a CP location solution, signaling to control and manage the location of mobile device 1200 may be exchanged between elements of network 170 and with mobile device 1200 using existing network interfaces and protocols and as signaling from the perspective of network 170. In a UP location solution, signaling to control and manage the location of mobile device 1200 may be exchanged between location server 160 and mobile device 1200 as data (e.g. data transported using the Internet Protocol (IP) and/or Transmission Control Protocol (TCP)) from the perspective of network 170.

As previously noted (and discussed in more detail below), the estimated location of mobile device 1200 may be based on measurements of RF signals sent from and/or received by the mobile device 1200. In particular, these measurements can provide information regarding the relative distance and/or angle of the mobile device 1200 from one or more components in the positioning system 100 (e.g., GNSS satellites 110, APs 130, base stations 120). The estimated location of the mobile device 1200 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 1200 may be estimated at least in part based on measurements of RF signals 140 communicated between the mobile device 1200 and one or more other UEs 145, which may be mobile or fixed. When or more other UEs 145 are used in the position determination of a particular mobile device 1200, the mobile device 1200 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and mobile device 1200 may comprise sidelink and/or similar Device-to-Device (D2D) communication technologies. Sidelink, which is defined by 3GPP, is a form of D2D communication under the cellular-based LTE and NR standards.

An estimated location of mobile device 1200 can be used in a variety of applications—e.g. to assist direction finding or navigation for a user of mobile device 1200 or to assist another user (e.g. associated with external client 180) to locate mobile device 1200. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 1200 may comprise an absolute location of mobile device 1200 (e.g. a latitude and longitude and possibly altitude) or a relative location of mobile device 1200 (e.g. a location expressed as distances north or south, east or west and possibly above or below some other known fixed location or some other location such as a location for mobile device 1200 at some known previous time). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 1200 is expected to be located with some level of confidence (e.g. 95% confidence).

The external client 180 may be a web server or remote application that may have some association with mobile device 1200 (e.g. may be accessed by a user of mobile device 1200) or may be a server, application, or computer system providing a location service to some other user or users which may include obtaining and providing the location of mobile device 1200 (e.g. to enable a service such as friend or relative finder, or child or pet location). Additionally or alternatively, the external client 180 may obtain and provide the location of mobile device 1200 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a mobile device 1200 by using access nodes 210, 214, 216 (which may correspond with base stations 120 and access points 130 of FIG. 1) and (optionally) an LMF 220 (which may correspond with location server 160) to implement one or more positioning methods. Here, the 5G NR positioning system 200 comprises a mobile device 1200, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one mobile device 1200 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The mobile device 1200 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, mobile device 1200 may correspond to a cellphone, smartphone, laptop, tablet, personal data assistant (PDA), navigation device, Internet of Things (IoT) device, or some other portable or moveable device. Typically, though not necessarily, the mobile device 1200 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The mobile device 1200 may also support wireless communication using a WLAN 216 which (like the one or more RATs, and as previously noted with respect to FIG. 1) may connect to other networks, such as the Internet. The use of one or more of these RATs may allow the mobile device 1200 to communicate with an external client 230 (e.g., via elements of 5G CN 240 not shown in FIG. 2, or possibly via a Gateway Mobile Location Center (GMLC) 225) and/or allow the external client 230 to receive location information regarding the mobile device 1200 (e.g., via the GMLC 225). The external client 230 of FIG. 2 may correspond to external client 180 of FIG. 1, as implemented in or communicatively coupled with a 5G NR network.

The mobile device 1200 may include a single entity or may include multiple entities, such as in a personal area network where a user may employ audio, video and/or data I/O devices, and/or body sensors and a separate wireline or wireless modem. An estimate of a location of the mobile device 1200 may be referred to as a location, location estimate, location fix, fix, position, position estimate, or position fix, and may be geodetic, thus providing location coordinates for the mobile device 1200 (e.g., latitude and longitude), which may or may not include an altitude component (e.g., height above sea level, height above or depth below ground level, floor level or basement level). Alternatively, a location of the mobile device 1200 may be expressed as a civic location (e.g., as a postal address or the designation of some point or small area in a building such as a particular room or floor). A location of the mobile device 1200 may also be expressed as an area or volume (defined either geodetically or in civic form) within which the mobile device 1200 is expected to be located with some probability or confidence level (e.g., 67%, 95%, etc.). A location of the mobile device 1200 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include NR NodeB (gNB) 210-1 and 210-2 (collectively and generically referred to herein as gNBs 210). Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to mobile device 1200 via wireless communication between the mobile device 1200 and one or more of the gNBs 210, which may provide wireless communications access to the 5G CN 240 on behalf of the mobile device 1200 using 5G NR. The wireless interface between base stations (gNBs 210 and/or ng-eNB 214) and the mobile device 1200 may be referred to as a Uu interface 239. 5G NR radio access may also be referred to as NR radio access or as 5G radio access. In FIG. 2, the serving gNB for mobile device 1200 is assumed to be gNB 210-1, although other gNBs (e.g. gNB 210-2) may act as a serving gNB if mobile device 1200 moves to another location or may act as a secondary gNB to provide additional throughput and bandwidth to mobile device 1200.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235—e.g. directly or indirectly via other gNBs 210 and/or other ng-eNBs. An ng-eNB 214 may provide LTE wireless access and/or evolved LTE (eLTE) wireless access to mobile device 1200. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of mobile device 1200 but may not receive signals from mobile device 1200 or from other UEs. It is noted that while only one ng-eNB 214 is shown in FIG. 2, some embodiments may include multiple ng-eNBs 214. Base stations 210, 214 may communicate directly with one another via an Xn communication interface. Additionally or alternatively, base stations 210, 214 may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for mobile device 1200 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by mobile device 1200 to other elements in 5G CN 240 and/or may support interworking of one or more protocols used by WLAN 216 and mobile device 1200 to one or more protocols used by other elements of 5G CN 240 such as AMF 215. For example, N3IWF 250 may support IPSec tunnel establishment with mobile device 1200, termination of IKEv2/IPSec protocols with mobile device 1200, termination of N2 and N3 interfaces to 5G CN 240 for control plane and user plane, respectively, relaying of uplink (UL) and downlink (DL) control plane Non-Access Stratum (NAS) signaling between mobile device 1200 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to SGCN 240 may occur if WLAN 216 is a trusted WLAN for SGCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the mobile device 1200 and the AMF 215. This can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, or WLAN 216 (alone or in combination with other components of the 5G NR positioning system 200), may be configured to, in response to receiving a request for location information from the LMF 220, obtain location measurements of uplink (UL) signals received from the mobile device 1200) and/or obtain downlink (DL) location measurements from the mobile device 1200 that were obtained by mobile device 1200 for DL signals received by mobile device 1200 from one or more access nodes. As noted, while FIG. 2 depicts access nodes 210, 214, and 216 configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to mobile device 1200, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to SGCN 240 in FIG. 2. The methods and techniques described herein for obtaining a civic location for mobile device 1200 may be applicable to such other networks.

The gNBs 210 and ng-eNB 214 can communicate with an AMF 215, which, for positioning functionality, communicates with an LMF 220. The AMF 215 may support mobility of the mobile device 1200, including cell change and handover of mobile device 1200 from an access node 210, 214, or 216 of a first RAT to an access node 210, 214, or 216 of a second RAT. The AMF 215 may also participate in supporting a signaling connection to the mobile device 1200 and possibly data and voice bearers for the mobile device 1200. The LMF 220 may support positioning of the mobile device 1200 using a CP location solution when mobile device 1200 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AOA), angle of departure (AOD), WLAN positioning, round trip signal propagation delay (RTT), multi-cell RTT, and/or other positioning procedures and methods. The LMF 220 may also process location service requests for the mobile device 1200, e.g., received from the AMF 215 or from the GMLC 225. The LMF 220 may be connected to AMF 215 and/or to GMLC 225. In some embodiments, a network such as SGCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a mobile device 1200's location) may be performed at the mobile device 1200 (e.g., by measuring downlink PRS (DL-PRS) signals transmitted by wireless nodes such as gNBs 210, ng-eNB 214 and/or WLAN 216, and/or using assistance data provided to the mobile device 1200, e.g., by LMF 220).

The Gateway Mobile Location Center (GMLC) 225 may support a location request for the mobile device 1200 received from an external client 230 and may forward such a location request to the AMF 215 for forwarding by the AMF 215 to the LMF 220. A location response from the LMF 220 (e.g., containing a location estimate for the mobile device 1200) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and mobile device 1200 to the external client 230, which may then be referred to as an Access Function (AF) and may enable secure provision of information from external client 230 to 5 GCN 240. NEF 245 may be connected to AMF 215 and/or to GMLC 225 for the purposes of obtaining a location (e.g. a civic location) of mobile device 1200 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.445. NRPPa messages may be transferred between a gNB 210 and the LMF 220, and/or between an ng-eNB 214 and the LMF 220, via the AMF 215. As further illustrated in FIG. 2, LMF 220 and mobile device 1200 may communicate using an LTE Positioning Protocol (LPP) as defined in 3GPP TS 37.355. Here, LPP messages may be transferred between the mobile device 1200 and the LMF 220 via the AMF 215 and a serving gNB 210-1 or serving ng-eNB 214 for mobile device 1200. For example, LPP messages may be transferred between the LMF 220 and the AMF 215 using messages for service-based operations (e.g., based on the Hypertext Transfer Protocol (HTTP)) and may be transferred between the AMF 215 and the mobile device 1200 using a 5G NAS protocol. The LPP protocol may be used to support positioning of mobile device 1200 using UE assisted and/or UE based position methods such as A-GNSS, RTK, TDOA, multi-cell RTT, AOD, and/or ECID. The NRPPa protocol may be used to support positioning of mobile device 1200 using network based position methods such as ECID, AOA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of mobile device 1200 access to WLAN 216, LMF 220 may use NRPPa and/or LPP to obtain a location of mobile device 1200 in a similar manner to that just described for mobile device 1200 access to a gNB 210 or ng-eNB 214. Thus, NRPPa messages may be transferred between a WLAN 216 and the LMF 220, via the AMF 215 and N3IWF 250 to support network-based positioning of mobile device 1200 and/or transfer of other location information from WLAN 216 to LMF 220. Alternatively, NRPPa messages may be transferred between N3IWF 250 and the LMF 220, via the AMF 215, to support network-based positioning of mobile device 1200 based on location related information and/or location measurements known to or accessible to N3IWF 250 and transferred from N3IWF 250 to LMF 220 using NRPPa. Similarly, LPP and/or LPP messages may be transferred between the mobile device 1200 and the LMF 220 via the AMF 215, N3IWF 250, and serving WLAN 216 for mobile device 1200 to support UE assisted or UE based positioning of mobile device 1200 by LMF 220.

In a 5G NR positioning system 200, positioning methods can be categorized as being “UE assisted” or “UE based.” This may depend on where the request for determining the position of the mobile device 1200 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, mobile device 1200 may obtain location measurements and send the measurements to a location server (e.g., LMF 220) for computation of a location estimate for mobile device 1200. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AOA, Receive Time-Transmission Time Difference (Rx-Tx), Differential AOA (DAOA), AOD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the mobile device 1200 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, mobile device 1200 may obtain location measurements (e.g., which may be the same as or similar to location measurements for a UE assisted position method) and may further compute a location of mobile device 1200 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AOA, or TOA) for signals transmitted by mobile device 1200, and/or may receive measurements obtained by mobile device 1200 or by an AP in WLAN 216 in the case of N3IWF 250, and may send the measurements to a location server (e.g., LMF 220) for computation of a location estimate for mobile device 1200.

Positioning of the mobile device 1200 also may be categorized as UL, DL, or DL-UL based, depending on the types of signals used for positioning. If, for example, positioning is based solely on signals received at the mobile device 1200 (e.g., from a base station or other UE), the positioning may be categorized as DL based. On the other hand, if positioning is based solely on signals transmitted by the mobile device 1200 (which may be received by a base station or other UE, for example), the positioning may be categorized as UL based. Positioning that is DL-UL based includes positioning, such as RTT-based positioning, that is based on signals that are both transmitted and received by the mobile device 1200. Sidelink (SL)-assisted positioning comprises signals communicated between the mobile device 1200 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AOD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AOD and/or AOA.

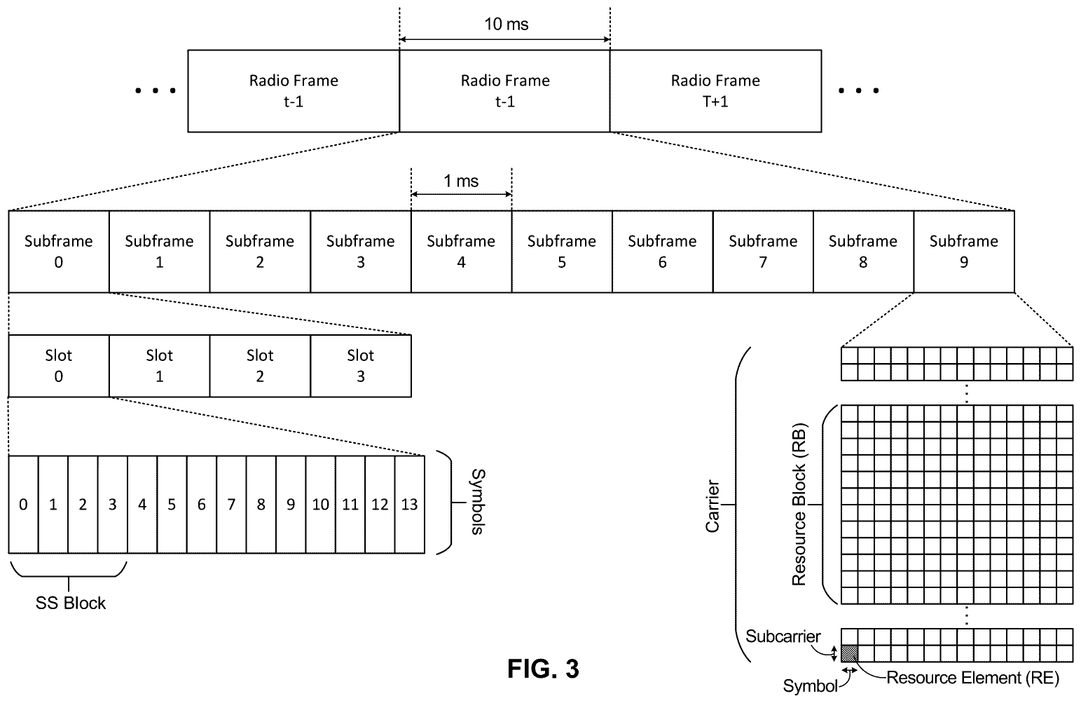

FIG. 3 is a diagram showing an example of a frame structure for NR and associated terminology, which can serve as the basis for physical layer communication between the mobile device 1200 and base stations, such as serving gNB 210-1. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 3 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 3. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

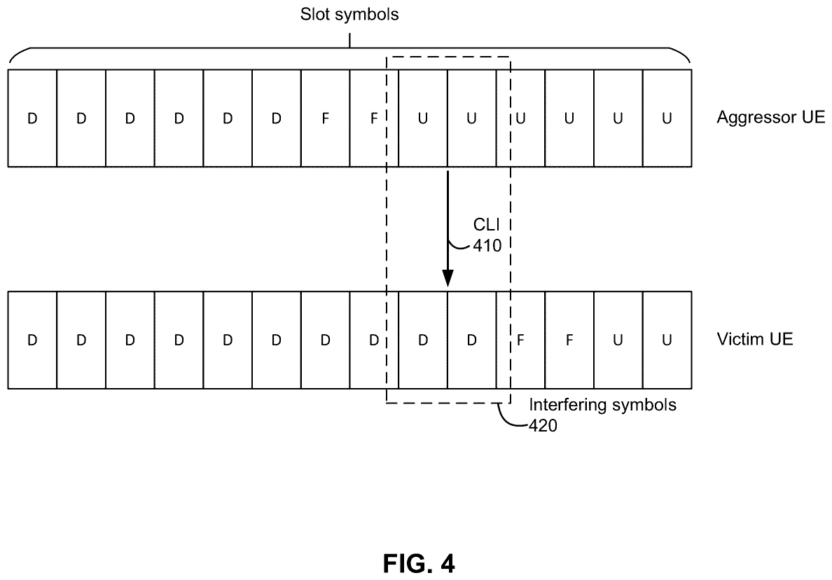

A mobile device may receive a configuration that designates each symbol of a slot as being used for DL or UL communications, or as being “flexible” (where DL/UL designation may be later determined). The time-division duplexing (TDD) aspect of the structure is subject to interference when transmissions are made at the wrong time. Such transmissions made other UEs (which may be configured differently) is known as CLI, which is discussed in more detail with regard to FIG. 4.

FIG. 4 is a diagram that illustrates an example of CLI. In this figure, the configurations of symbols of a slot for to UEs are shown. Each symbol is represented by a box, where “D” represents symbols configured for DL communications, “U” represents symbols configured for UL communications, and “F” are symbols designated as flexible.

CLI is a UE to UE interference, where the UE causing the interference is known as the “aggressor UE” and the UE receiving the interference is known as the “victim UE.” Because UEs in a TDD wireless communication network (e.g., a 5G NR network that uses the OFDM structure illustrated in FIG. 3) have different UL-DL slot configurations, this can result and “collisions” where the victim UE receives a transmission (e.g., CLI 410) from an aggressor UE. Specifically, CLI 410 can occur during one or more symbols (interfering symbols 420) where the aggressor UE has one or more UL symbols that collide with one or more DL symbols of the victim UE. These transmissions by the aggressor UE can include any of a variety of transmissions, including, for example, a PUCCH, a PUSCH, a Physical Random Access Channel (PRACH) preamble, or an SRS. It can be noted that the diagram of FIG. 4 is just one of many types of CLI that may occur. Other CLI may occur, for example, at one or more different places within a slot, may use a single symbol or more symbols, and/or may occur during multiple non-contiguous symbols, etc.

According to embodiments herein, CLI can be leveraged as a reference signal for positioning. That is, according to some embodiments, the network (e.g., serving base station), which configures the slot usage by the different UEs and also configures CLI resources for interference management, may configure UEs such that CLI interference occurs, where a target UE and anchor UE are respectively the victim UE and aggressor UE. The target (victim) UE may be configured to measure the CLI 410.

Again, according to some embodiments, this procedure may not impact the UL transmission of the aggressor UE. That is, UL transmissions by the anchor (aggressor) UE may be standard transmissions (PUCCH, PUSCH, SRS, etc.) made by the anchor UE in the course of communications or other non-positioning functions, which are leveraged for purposes of determining the position of the target UE. Thus, the configuration of the anchor UE may not be impacted by this positioning procedure.

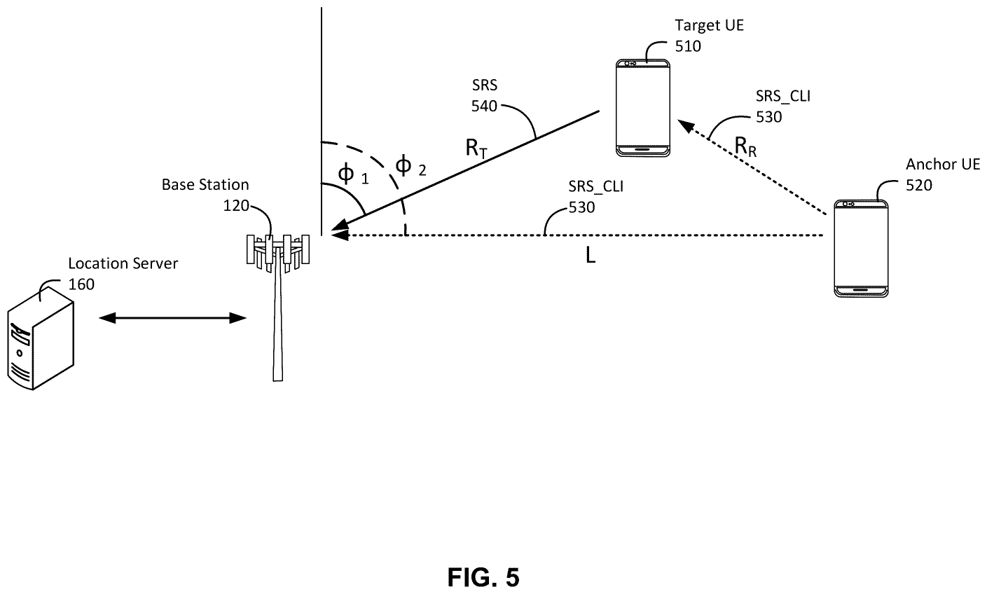

According to some embodiments, the procedure may leverage other capabilities currently provided by governing standards. For example, Release 16 of the relevant 3GPP standards has defined Layer-3 measurement and reporting mechanisms for CLI. Thus, according to some embodiments, the target (victim) UE may report this measurement to the network and may do so in accordance with existing standards. The measurement of the CLI 410 may comprise an SRS-RSRP and/or CLI RSSI, for example. Further (and optionally in accordance with existing governing standards) the target UE may receive a measurement resource configuration in which the target UE can measure and report periodicity, frequency RBs, and OFDM symbols of the CLI 410. FIG. 5 illustrates how this measurement information can be used in the context of determining the position of the target UE.

FIG. 5 is a simplified diagram illustrating how a CLI-aided hybrid network position determination of a target UE 510 may be made using a single base station 120 (e.g., the serving base station of the target UE 510 and/or anchor UE 520), according to an embodiment. Here, positioning of the target UE 510 is accomplished using wireless reference signals 530, 540 transmitted by the anchor UE 520 and target UE 510. More specifically, the anchor UE 520 transmits SRS_CLI 530, which is received by both of the target UE 510 and base station 120. Because the SRS_CLI 530 may occur during symbols for which target UE 510 is configured for DL communications, the SRS_CLI 530 behaves as CLI, as previously described, where the anchor UE 520 is the aggressor UE and the target UE 510 is the victim UE. In response to receiving the SRS_CLI 530, the target UE 510 transmits SRS 540, which is received by the base station 120. This processes described in more detail herein below. Positioning and this manner may be facilitated with the use of a location server 160. It can be noted that, although indicated in the diagram an described herein below as SRS signals, embodiments may use additional or alternative types of wireless signals as the wireless reference signals in the same manner.

The position of the target UE 510 can be determined mathematically by solving for the distance, R_{T}, of the target UE 510 from the base station 120, as well as angle, ϕ₂-ϕ₁ (although, as described hereafter, some embodiments may perform multilateration using multiple anchor UEs rather than solving for the angle). It can be noted that the baseline from which the angles ϕ₁ and ϕ₂ are measured may be measured from true north or based on any coordinate system used by the network for positioning (e.g., geographical coordinates, East-North-Up (ENU), etc. Solving for these variables can be done using timing measurements at the target UE 510 and base station 120, as well as angle measurements at the base station.

The distance R_{T} can be determined based on a time difference at the base station 120 of receiving the SRS 540 and SRS_CLI 530. Where Rₛᵤₘ, is the combined distance of distance R_{T} and the distance, R_{R}, between the target UE 510 and anchor UE 520, then solving for R_{T} results in the following expression:

R_{T}=Rₛᵤₘ−R_{R}. (1)

If R is defined as the distance between the base station 120 and anchor UE 520, then equation (1) can be mathematically modified as follows:

$${R}_{T} = \frac{{R}_{sum}^{2} - {L}^{2}}{2 [ {R}_{sum} - L * cos ( {ϕ}_{2} - {ϕ}_{1} ) ]} . \qquad ( 2 )$$

Because the location of the anchor UE 520 is known (or can be determined beforehand), distance L and angle ϕ₂ can be obtained based on this location and the known location of the base station 120 (e.g., from an almanac of base station locations stored by the location server 160, base station 120, or target UE 510). Additionally, as explained in further detail below, ϕ₁ can be determined from an AoA measurement by the base station 120 of the SRS 540. Thus, once Rₛᵤₘ is determined, range R_{T} can be determined using equation (2).

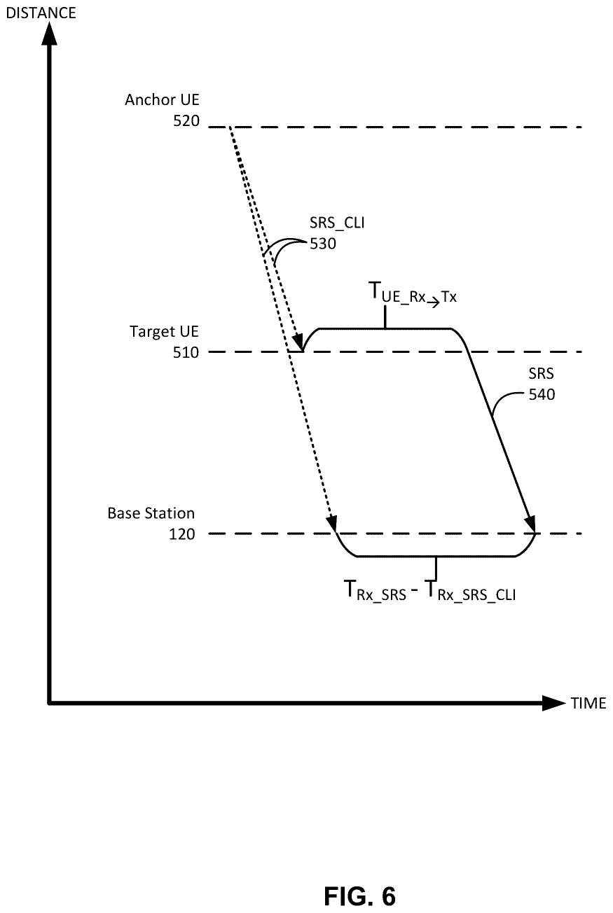

To solve for Rₛᵤₘ, embodiments can determine two time differences: (i) a time at which the SRS_CLI 530 is received at the target UE 510 and a time when SRS 540 is sent from the target UE 510, and (ii) a time difference between the time the base station 120 receives SRS_CLI 530 and the time the base station 120 receives and SRS 540. The SRS 540 sent from the target UE 510 to the base station 120 can be triggered by the receipt of the SRS_CLI 530 at the target UE 510. As described in further detail below, different devices may determine the location of the target UE 510, depending on desired functionality. As such, one or both of these time differences may be sent to the device making the determination. The determination of the location of the target UE 510 based on these time differences is described in further detail with regard to FIG. 6.

FIG. 6 is a time-distance diagram illustrating how timing can be used to determine Rₛᵤₘ in the configuration shown in FIG. 5, according to an embodiment. Here, an anchor UE 520 transmits a reference signal, SRS_CLI 530, which is received by both the target UE 510 and base station 120. Again, the anchor UE 520 and target UE 510 are configured such that the SRS_CLI 530 is received by the target UE 510 at a time during which the target UE 510 is configured for DL communications (e.g., from one or more base stations of the wireless network). As such, the SRS_CLI 530 is CLI, where the anchor UE 520 is acting as the aggressor UE, and the target UE 510 is acting as the victim UE. In the diagram of FIG. 6, the different angles of SRS_CLI 530 between anchor UE 520, target UE 510, and base station 120 represent different paths taken by the SRS_CLI 530.

Because reference signals travel at approximately the speed of light, c, the value for Rₛᵤₘ can be determined from:

Rₛᵤₘ=(T_{Rx_SRS}−T_{Rx_SRS_CLI}−T_{UE_Rx→Tx})*C+L (3)

where T_{RX_SRS} is the time (ToA) at which SRS 540 is received by the base station 120, T_{RX_SRS}_CLI is the time (ToA) at which SRS_CLI 530 is received by the base station 120, and T_{UE_RX→TX} is the time difference between the time (ToA) at which the target UE 510 receives the SRS_CLI 530 and the time at which the target UE 510 transmits the SRS 540. With the value of Rₛᵤₘ, distance R_{T} can be determined from equation (2) above, and the position of the target UE 510 can be determined based on distance R_{T}, angle ϕ₂-ϕ₁, and the positions of the base station 120 and anchor UE 520. Because the value of Rₛᵤₘ is based time differences that can be separately calculated at the target UE 510 and base station 120, no synchronization is required between the target UE 510, anchor UE 520, or base station 120 to perform the positioning of the target UE 510 using the techniques described herein.

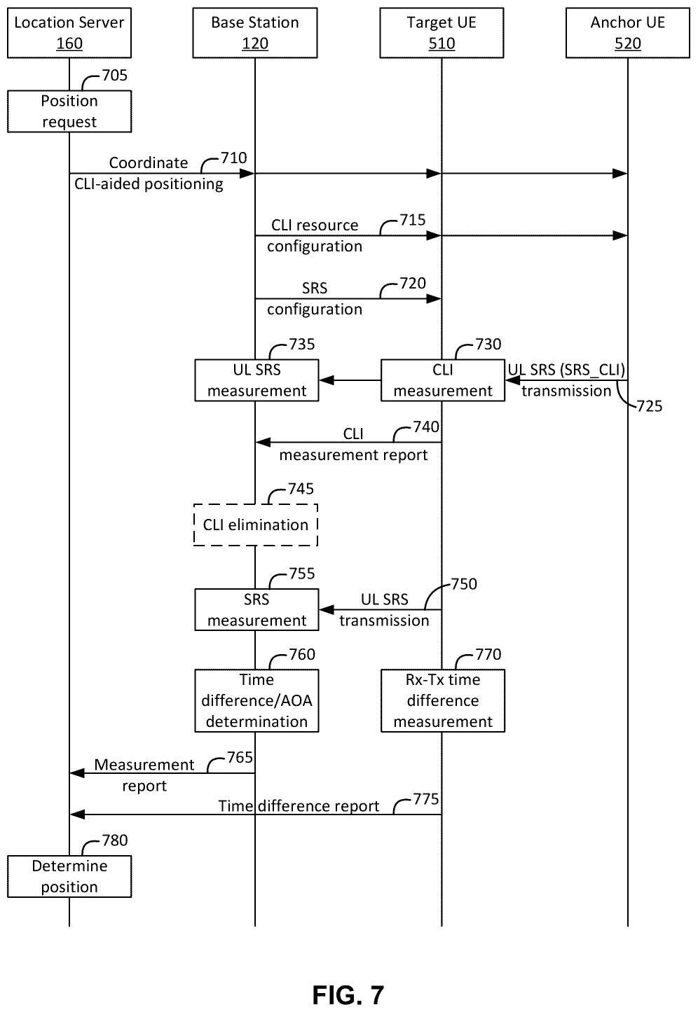

As noted, the calculation of the position of the target UE 510 and/or values distance R_{T} and angle ϕ₂-ϕ₁ may be performed by different devices, depending on desired functionality. This may depend, for example, on whether the position of the target UE 510 is UE-based or UE-assisted (e.g., where the request for the position of the target UE 510 comes from the network or other entity outside the anchor UE, such as the external client 180 of FIG. 1 or external client 230 of FIG. 2). Accordingly, different processes can be used to determine the position of the target UE 510. FIGS. 7-9 illustrate some example processes.

FIG. 7 is a call flow diagram illustrating a process of CLI-aided hybrid network positioning of a mobile device (target UE 510), according to an embodiment. In this embodiment, a location server 160 determines the position of the target UE 510 based on inputs received from the target UE 510 (and other inputs). As such, this type of positioning may be considered a UE-assisted positioning. As with other figures provided herein, FIG. 7 is provided as a nonlimiting example. As discussed in more detail below, alternative embodiments may perform certain functions (e.g., the determination of the anchor UE position, the AoA measurement, the ToA measurements, etc.) in a different order, simultaneously, etc. It can be noted that arrows between the various components illustrated in FIG. 7 illustrate messages or information sent from one component to another, which can be sent in accordance with applicable communication standards between the various devices (e.g., LPP, NRPPa, etc.). It will be understood, however, that there may be any number of intervening devices, servers, etc. that may relay such messages, including other components in FIG. 7. (E.g., a message from the target UE 510 to the location server 160 may pass through the base station 120 and perhaps the anchor UE 520.) Additionally, although wireless reference signals are referred to as SRS, alternative embodiments may utilize additional or alternative wireless reference signal types.

At block 705, the location server 160 obtains a position request. As noted, the location server 160 may receive position requests from functions within a positioning system (e.g., 5G NR positioning system 200 of FIG. 2) and/or external client (e.g., external client or AF 230). This may be based, for example, on services provided to the target UE 510, actions taken by the target UE 510 (e.g., calling an emergency number), or the like. Additionally or alternatively, the request may be received from another mobile device, if authorized to do so (e.g., anchor UE 520 or some other device).

In response, the location server 160 can coordinate CLI-aided positioning, as shown at arrows 710. As illustrated, this can include communicating to the base station 120, target UE 510, and/or anchor UE 520. When communicating with the target UE 510, the location server 160 can initiate a positioning session (e.g., LPP positioning session), and may obtain the capabilities of the target UE 510. This may comprise the target UE 510 providing the location server 160 with its capabilities with regard to accuracy, the types of positioning measurements it can perform, whether it is capable of CLI-aided positioning, etc.

When communicating with the anchor UE 520, the location server 160 can also obtain the capabilities of the anchor UE 520. This may comprise the anchor UE 520 providing the location server 160 with its capabilities with regard to accuracy, its capabilities of supporting CLI-aided positioning, etc. However, as previously indicated, according to some embodiments, the anchor UE 520 may transmit and SRS_CLI (or similar wireless reference signal) in the course of normal communications (e.g., with the base station 120). As such, according to some embodiments, the location server 160 may not communicate with the anchor UE 520 at all. Instead, the anchor UE 520 may be configured only by the base station 120.

Further, according to some embodiments, the communication with the anchor UE 520 may comprise a position request. This can notify the anchor UE 520 of a position determination of the target UE 510 and/or trigger the anchor UE 520 to obtain its position information. In such instances, this may initiate a positioning session between the location server 160 and anchor UE 520, in which case the location server 160 may request the position of the anchor UE 520, which may be provided to the location server 160, if known. Otherwise, the anchor UE 520 may obtain its location, which may involve using RAT-independent methods (e.g., positioning based on GNSS, WLAN, etc.). Additionally or alternatively, the anchor UE 520 may obtain its location using RAT-dependent methods, which may involve UE-assisted positioning of the anchor UE 520.

The selection of an anchor UE 520 to use in the position determination of the target UE 510 may be made in any of a variety of ways, depending on desired functionality. For example, the target UE 510 may have an existing sidelink communication channel with an anchor UE 520 that can be leveraged for positioning purposes. In such instances, the anchor UE 520 may be selected based on an existing sidelink channel. Additionally or alternatively, the anchor UE 520 may be selected by the target UE 510 based on a scan of nearby UEs as well as a confirmed capability of performing positioning and this manner. Some embodiments may use a signal quality metric such as Signal-to-Noise Ratio (SNR) and/or RSSI, for example, to select of the anchor UE 520. Signal quality measures can be used to select an anchor UE 520 that has adequate signal quality to perform the functions described herein, while not being too close to the target UE 510 to result in positioning errors for the position determination of the target UE 510. Accordingly, in such embodiments, a certain range of SNR and/or RSSI values may be selected to balance these considerations, and anchor UEs having SNR and/or RSSI values that fall within this range may be selected over other anchor UEs having SNR and/or RSSI values falling outside this range. Other embodiments may utilize additional or alternative techniques for anchor UE selection.

When communicating to the base station 120, the location server 160 may identify the target UE 510, one or more anchor UEs 520 (e.g., nearby UEs 520 for which position is known or can be determined), timing requirements, accuracy requirements, capabilities of the target UE 510, etc.

As shown by arrow 715, the base station 120 can then send a CLI resource configuration to the target UE 510. The CLI resource configuration 715 may, among other things, configure the target UE 510 for DL communications during CLI (e.g., as discussed in reference to FIG. 4), and configure the target UE 510 to take measurements of the CLI. Optionally, the base station 120 may further configure anchor UE 520 to transmit the wireless reference signal (e.g., SRS_CLI 530). But again, the wireless reference signal transmitted by the anchor UE 520 may be made in the course of other functionality (e.g., standard communication), in which case the base station 120 may not send a CLI resource configuration 715. Further, if the wireless reference signal is made in the course of other functionality, the CLI resource configuration 715 provided by the base station 120 to the target UE 510 may be made in light of the timing of the wireless reference signal. In other words, the base station 120 can, in view of the timing of a signal transmitted by the anchor UE 520 that could be used as a wireless reference signal for CLI, configure the target UE 510 (using CLI resource configuration 715) to measure the wireless reference signal transmitted by the anchor UE 520.

At arrow 720, the base station 120 sends and SRS configuration to the target UE 510. This SRS configuration may comprise timing, frequency, and/or other aspects of the wireless reference signal (e.g., SRS 540) to be transmitted by the target UE 510 and measured by the base station 120. Again, according to alternative embodiments, other types of reference signals may be used. According to some embodiments, the SRS configuration 720 may be combined with CLI resource configuration 715.

At arrow 725, the anchor UE 520 transmits the wireless reference signal, UL SRS (SRS_CLI), which is measured by the target UE at block 730 and by the base station at block 735. Again, the transmission of the UL SRS (SRS_CLI) by the anchor UE 520 may be in response to communication/configuration received from the location server 160 (e.g., arrow 710) and/or base station 120 (e.g., arrow 715). Additionally or alternatively, the anchor UE 520 may transmit the UL SRS at arrow 725 in the course of performing other, non-positioning functionality (e.g., mobility, data communications, etc.).

At arrow 740, the target UE 510 provides a CLI a measurement report of the CLI measurement taken at block 730 to the base station 120, which, optionally, performs CLI elimination at block 745. This functionality by the target UE 510 and base station 120 may be in accordance with governing specifications for reporting CLI. However, because the CLI received at the target UE 510 is intentional, actions to correct or compensate for the CLI may not need to be taken.

At arrow 750, the target UE 510 transmits the UL SRS, which is measured by the base station at block 755. The transmission of the UL SRS (e.g., SRS 540) may be in accordance with the SRS configuration received by the target UE 510 at arrow 720.

At block 760, the base station 120 determines the time difference and AoA based on the measurements of the UL SRS from the anchor UE 520 (measured at block 735) and the UL SRS from the target UE 510 (measured at block 755). More particularly, the base station 120 may measure the ToA of each of the signals and may determine the time difference T_{Rx_SRS}-T_{Rx_SRS_CLI} (e.g., of FIG. 6 and equation (3)). The AoA measurement information may comprise separate AoA measurements for angles ϕ₁ and ϕ₁ (e.g., of FIG. 5), and/or may comprise a differential AoA (DAoA) measurement of the angle ϕ 2— C. At arrow 765, the base station 120 provides a measurement report to the location server 160 comprising this time difference and AoA measurement information.

Additionally, at block 770, the target UE 510 determines an Rx→Tx time difference measurement. More particularly, the target UE 510 measures the ToA of the wireless reference signal (UL SRS (SRS_CLI)) transmitted at arrow 725 and determines an Rx→Tx time difference (e.g., T_{UE_Rx→Tx} of FIG. 6 and equation (3)) between a time the wireless reference signal is received at the target UE 510 (at block 730) and a time the target UE 510 transmits the UL SRS at arrow 750. This information is then provided by the target UE 510 in a time difference report to the location server 160, as indicated at arrow 775.

With this information, the location server then determines the position of the target UE, as indicated at block 780. According to some embodiments, for example, the location server can use the information provided in the measurement report at arrow 765 and the time difference report at arrow 775, along with information regarding the positions of the base station 120 and anchor UE 520, to determine the distance, R_{T}, between the base station 120 and target UE using equation (2). Together with angle information from the base station 120, this can be used to solve the location of the target UE 510. The location server 160 can then provide the position of the target UE 510 to the requesting entity (not shown).

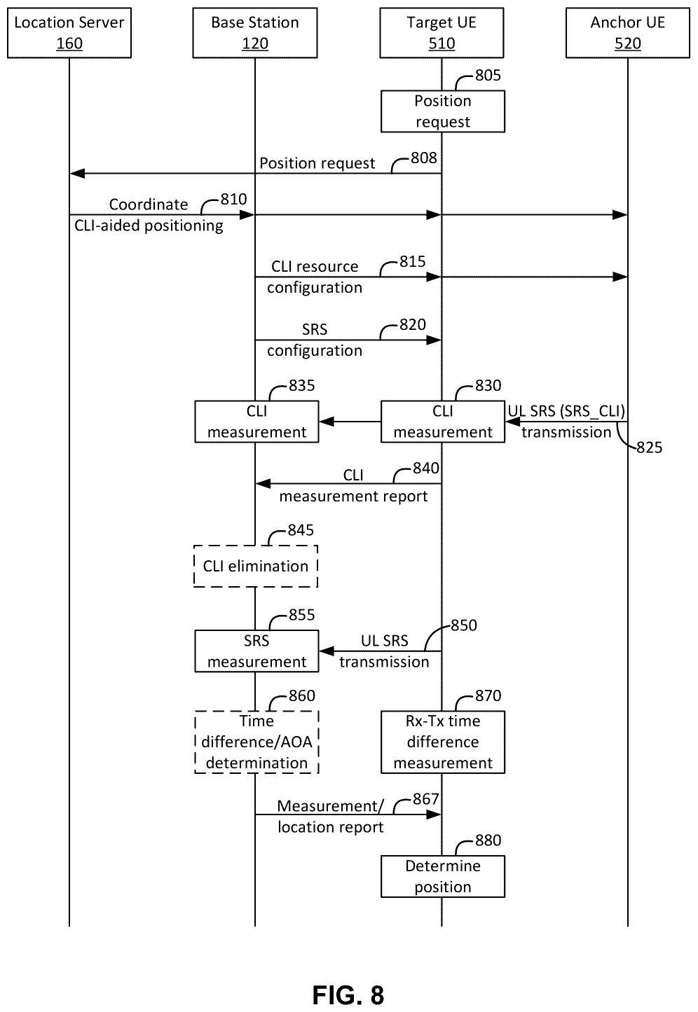

FIG. 8 is call-flow diagram illustrating of another process of CLI-aided hybrid network positioning of a mobile device (target UE 510), according to an embodiment. In contrast to the process illustrated in FIG. 7, however, calculations and position determination are performed at the target UE 510 itself. As can be seen, many of the operations performed in the process of FIG. 8 may be similar to the operations performed in the process of FIG. 7. The calculations, too, may be similar to the calculations performed in the process of FIG. 7 (e.g., using equations (1)-(3)).

At block 805, the target UE 510 obtains a position request. This position request may come, for example, from an application (or “app”) executed by the target UE 510. This may be a result from user interaction with the target UE 510, based on a determined schedule, or based on other triggers. Additionally or alternatively, a position request may come from a separate, authorized device (e.g., the anchor UE 520 or another device in communication with the target UE 510) requesting the position of the target UE 510.

In response, the target UE 510 may generate a position request notification. As indicated at arrow 808, the request can be sent to the location server 160, which can coordinate the functionality of the various components illustrated in FIG. 8 to determine of the position of the target UE 510, as indicated at arrow 810. This coordination functionality may be similar to the coordination at arrow 710 of FIG. 7 previously described. Again, according to some embodiments, additional communications between the target UE 510 and location server 160 may occur to determine capabilities of the target UE 510 (including, for example, the capability of the target UE 510 to communicate with the anchor UE 520). In some embodiments, communication between the location server 160 and target UE 510 may occur via an LPP positioning session.

The elements 815-870 of the process in FIG. 8 may be similar to corresponding elements 715-770 as previously explained with regard to FIG. 7. Here, however, the target UE 510 does not provide a time difference report to the location server 160 (e.g., as was done at arrow 775 of FIG. 7), but instead retains that information to perform positioning calculations itself. Additionally, rather than send a measurement report to the location server 160 (e.g., at arrow 765) the base station 120 can provide time difference and AoA measurement information to the target UE 510, as indicated at arrow 867. Additionally, this report may include the location of the base station 120 and/or anchor UE 520, enabling the target UE 510 to determine its position at block 880. Alternatively, according to some embodiments, the location of the anchor UE 520 may be provided by the anchor UE 520 itself (e.g., using sidelink communications with the target UE 510). Additionally or alternatively, the location of the base station 120 and/or anchor UE 520 may be provided to the target UE 510 by the location server 160. According to some embodiments, the known location of the base station 120 may be obtained by the target UE 510 based on an almanac of base station locations, which may be stored at the target UE 510 or location server 160. If stored at the location server 160, the location server may provide the location of the base station 120 as assistance data in previous communications (e.g., at arrow 810 or separately-communicated assistance data (not shown)).

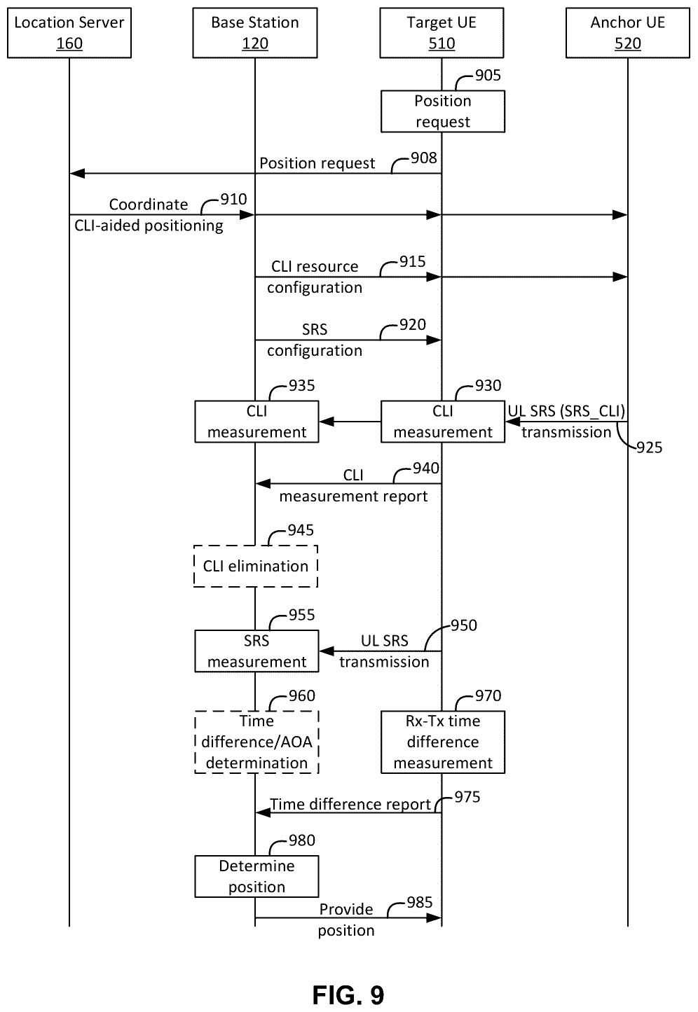

FIG. 9 is call-flow diagram illustrating yet another process of CLI-aided hybrid network positioning of a mobile device (target UE 510), according to an embodiment. Here, calculations and position determination are performed at the base station 120. Again, as can be seen, many of the operations performed in the process of FIG. 9 may be similar to the operations performed in the processes described previously with regard to FIGS. 7 and 8.

In the process of FIG. 9, similar to the process of FIG. 8, the target UE 510 may receive a position request at block 905 and send a corresponding position request to the location server 160 at arrow 908. Here, however, rather than retaining the time difference information to perform the positioning calculation itself, the target UE 510 may provide the time difference report to the base station 120, as indicated at arrow 975, to allow the base station 120 to determine the position at block 980. The base station 120 can then provide the calculated position to the target UE 510, as indicated at arrow 985.

In the processes of FIGS. 8 and 9, where the target UE 510 receives the position request 905 and ultimately obtains its position, the target UE 510 may subsequently provide the position in any of a variety of ways, which may depend on what initiated the position request. For example, the target UE 510 may provide a position via a user interface of the target UE 510 via a display and/or to application executed by the target UE 510. Additionally or alternatively, the target UE 510 may provide the determined position to an application executed by the target UE 510. In the latter case, the determined position may be provided to the application by a lower hardware and/or software layer, such as an operating system, a processor of a wireless communication interface (e.g., modem), etc.

As a person of ordinary skill in the art will appreciate, the flows provided in FIGS. 7-9 are provided as non-limiting examples. Alternative embodiments may implement any of a variety of changes, including different devices that receive and respond to position requests, different devices that receives measurement information (and/or information derived therefrom) and determine the position of the target UE 510, etc.

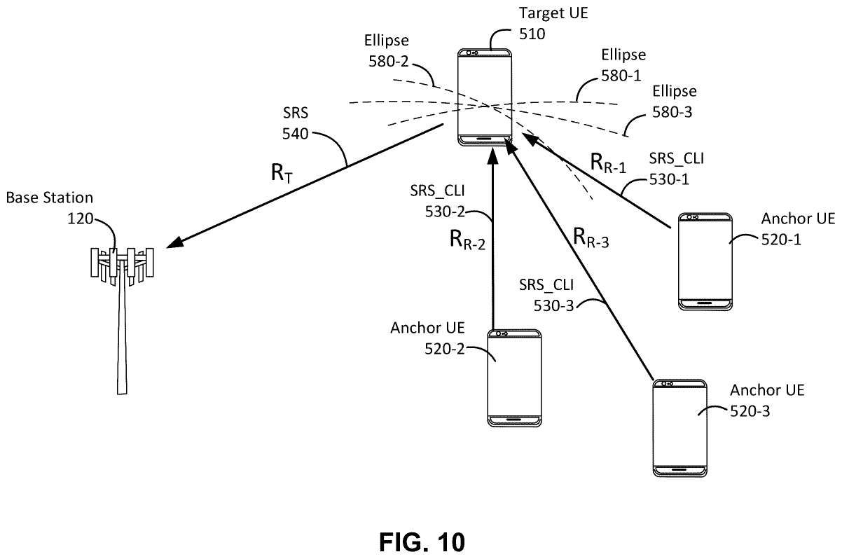

FIG. 10 is a simplified diagram illustrating an example variation to the configuration illustrated in FIG. 5, which may be used according to some embodiments. Here, rather than a single anchor UE 520, multiple anchor UEs 520-1, 520-2, and 520-3 (collectively and generically referred to herein simply as anchor UEs 520) are used. Among various reasons that the use of multiple anchor UEs 520 may be advantageous over the use of a single anchor UE 520 is the reduction of any impact of potential blockage of one anchor UE 520. This provides for a more robust positioning of the target UE 510 in the presence of an environment that may block signals between and anchor UE 520 and the target UE 510 and base station 120.

The process of determining the location of the target UE 510 may be generally similar to the process illustrated in FIG. 5 and described in conjunction with FIGS. 5-9. However, because multiple anchor UEs 520 are used, angle information may not be needed. That is, rather than (or in addition to) determining the position of the target UE 510 using distance R_{T} and angle ϕ₂-ϕ₁, the position may be determined instead using multi-lateration. For multi-lateration, each anchor UE 520 can transmit a respective SRS_CLI 530, which is measured by both the target UE 510 and the base station 120. (To reduce clutter, signals from each anchor UE 520 to the base station 120 have been omitted from FIG. 10.) The process described previously with respect to FIG. 5 can then be applied to each anchor UE 520, where Rₛᵤₘ, is determined using equation (3). Because Rₛᵤₘ is the sum of R_{T} and the respective R_{R} for each anchor UE 520, the value of Rₛᵤₘ can be used to form a respective ellipse 580 for each anchor UE 520, where the base station 120 and anchor UE 520 are foci of the respective ellipse. (Again, to reduce clutter, only applicable portions of ellipses 580 are illustrated in FIG. 10) The device determining the location of the target UE 510 (e.g., the target UE 510, any/all of the anchor UEs 520, or the location server 160 (not illustrated in FIG. 10)) may do so by determining the pointed which the ellipses 580 converge. As such, no AoA or other angular determinations may be needed. That said, the base station 120 may optionally make AoA measurements of the SRS 540 and/or one or more of the SRS_CLI 530, in which case this angular information can be used as an additional data point for determining and/or verifying the location of the target UE 510.

The number of anchor UEs 520 used to determine the position of the target UE 510 in this manner may vary, depending on the situation. A larger or smaller number of anchor UEs 520 than illustrated in FIG. 10, for example, can be used. In some circumstances, such as when two anchor UEs 520 are used, there may be ambiguities (e.g., multiple convergence points) in the position of the target UE 510. In such instances, other data can be leveraged to resolve the ambiguities. This other data can include, for example, tracking information for the target UE 510, other (previous and/or simultaneous) position determinations for the target UE 510, or the like.

It can be noted that embodiments for determining the location of the target UE 510 in the manner illustrated in FIG. 10 may follow a similar process as those illustrated in FIGS. 7-9. (As noted above, a determination of AoA by the base station 120 may be optional. Thus, actions related to the AoA determination described in FIGS. 7-9 may be optional as well.) Because multiple anchor UEs 520 are used, the functionality of the anchor UE 520 illustrated in FIGS. 7-9 may be replicated for all anchor UEs 520.

It also can be noted that the target UE 510 may transmit the same or different SRS 540 for each anchor UE 520, depending on desired functionality. For example, a the target UE 510 may transmit a single SRS 540 after receiving SRS_CLI 530-1, SRS_CLI 530-2, and SRS_CLI 530-3, and the respective value for T_{UE_RX→Tx} for each anchor UE 520 used to determine the position of the target UE 510 can be based on the time differences between each SRS_CLI and the single SRS 540 transmitted by the target UE 510. In another example, the target UE 510 may send and SRS 540 corresponding to two or more SRS_CLI 530 received from a corresponding two or more anchor UEs 520. Again, the value for T_{UE_Rx-43 Tx} can be reflective of the use of the SRS 540 in this manner. Different embodiments may employ different combinations of reference signals.

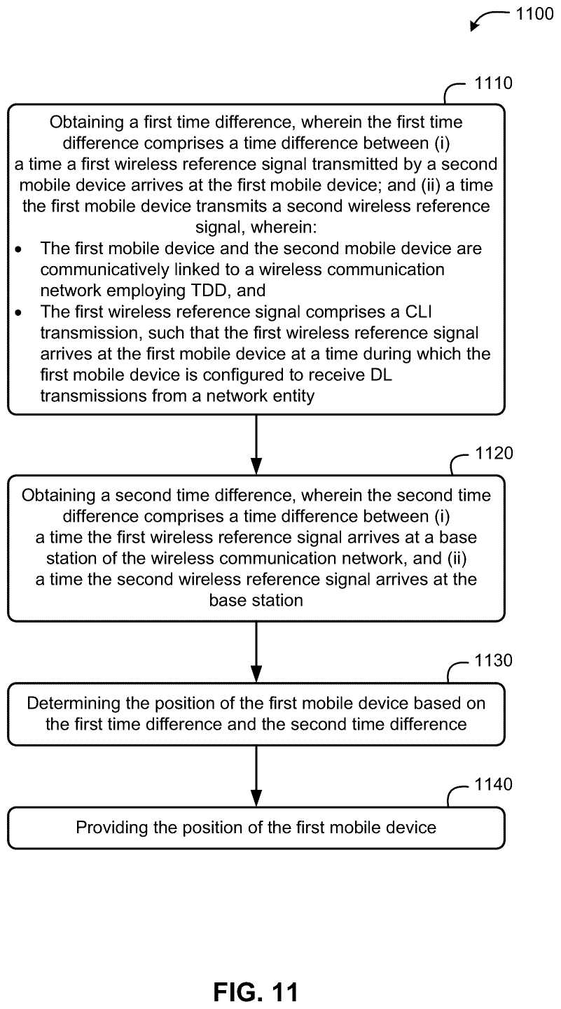

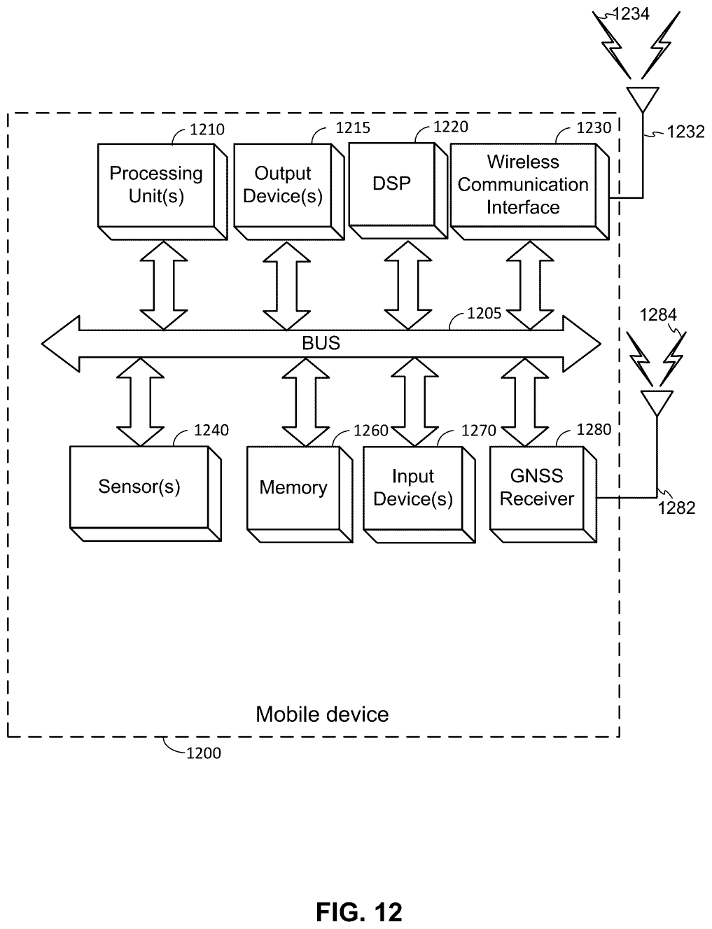

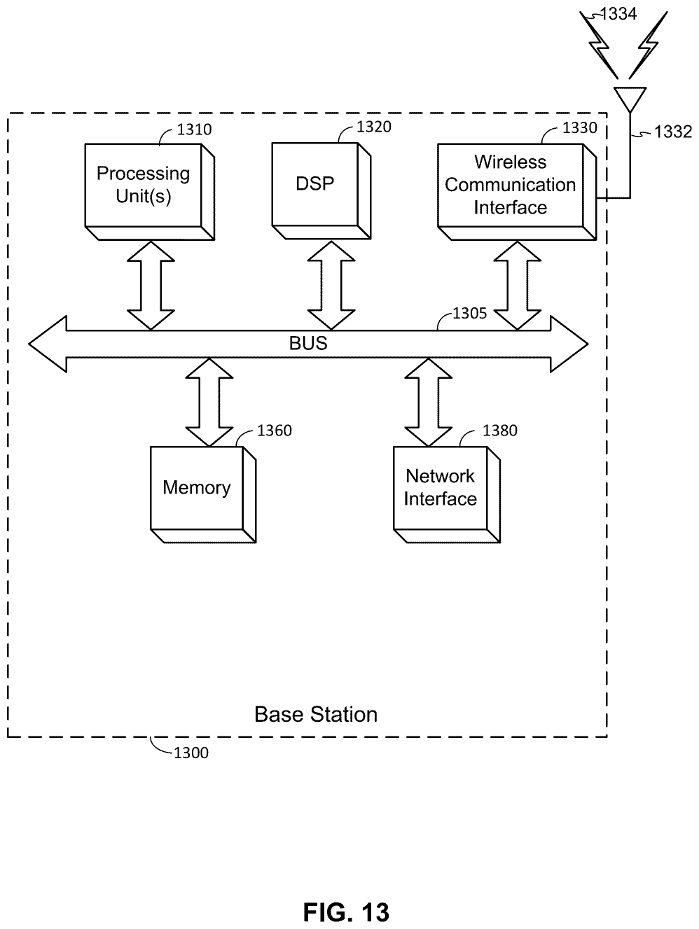

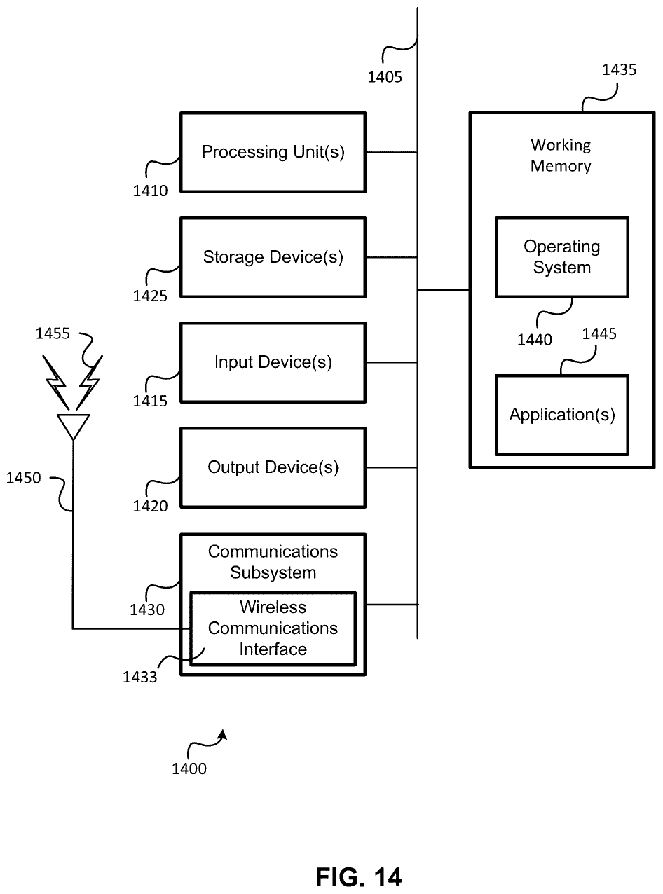

FIG. 11 is a flow diagram of a method 1100 of determining the position of a first mobile device, according to an embodiment. Here, the first mobile device may correspond with the target UE 510, and the second mobile device may correspond with the anchor UE 520, as described in FIGS. 5-10. Further, as illustrated in the example processes of FIGS. 7-9 and the descriptions of FIGS. 5 and 10, the operations performed by different devices may vary, depending on factors such as whether positioning is UE-assisted or UE-based, and/or other factors. Accordingly, means for performing the functionality illustrated in one or more of the blocks shown in FIG. 11 may be performed by hardware and/or software components of a target UE 510, anchor UE 520, base station 120, or location server 160. Example components of a mobile device and/or UE are illustrated in FIG. 12; example components of a base station 120 are illustrated in FIG. 13; and components of a location server are illustrated in FIG. 14 and described in more detail below.

At block 1110, the functionality comprises obtaining a first time difference, wherein the first time difference comprises a time difference between (i) a time a first wireless reference signal transmitted by a second mobile device arrives at the first mobile device; and (ii) a time the first mobile device transmits a second wireless reference signal, wherein the first mobile device and the second mobile device are communicatively linked to a wireless communication network employing TDD, and the first wireless reference signal comprises a CLI transmission, such that the first wireless reference signal arrives at the first mobile device at a time during which the first mobile device is configured to receive DL transmissions from a network entity. An example of this first time difference is provided in equation (3) as T_{UE_Rx→Tx}, which, as noted, can be used to account for delays at the first mobile device (e.g., target UE 510) when determining Rₛᵤₘ. As previously noted, according to some embodiments, the first wireless reference signal (e.g., SRS_CLI of FIGS. 5 and 10) may comprise an SRS. According to some embodiments, the second wireless reference signal (e.g., SRS 540 of FIGS. 5 and 10) comprises an UL transmission comprising a PUCCH, a PUSCH, a PRACH preamble, or an SRS, or a combination thereof. In some embodiments, the network entity from which the first mobile device is configured to receive downlink DL transmissions may comprise a serving or neighboring base station of the first mobile device, or another TRP of the wireless communication network. As noted, according to some embodiments, determining the first time difference is performed at the first mobile device, which can measure/calculate the time difference based on a ToA of the first wireless reference signal and a time of transmission of the second wireless reference signal. As noted in the examples illustrated in FIGS. 7-9 information can be obtained, for example, by a location server or base station that determines the position of the first mobile device or retained by the first mobile device to determine its own position.

Means for performing functionality at block 1110 may comprise a bus 1205, wireless communication interface 1230, digital signal processor (DSP) 1220, processing unit(s) 1210, memory 1260, and/or other components of a mobile device, as illustrated in FIG. 12. Additionally or alternatively, means for performing functionality at block 1110 may comprise a bus 1305, wireless communication interface 1330, DSP 1320, processing unit(s) 1310, memory 1360, and/or other components of a base station, as illustrated in FIG. 13. Additionally or alternatively, means for performing functionality at block 1110 may comprise a bus 1405, communications subsystem 1430, processing unit(s) 1410, working memory 1435, and/or other components of a computer, as illustrated in FIG. 14.

At block 1120, the functionality comprises obtaining a second time difference, wherein the second time difference comprises a time difference between (i) a time the first wireless reference signal arrives at a base station of the wireless communication network, and (ii) a time the second wireless reference signal arrives at the base station. An example of a second time difference is provided in equation (3) as T_{RX_SRS}-T_{RX_SRS}_CLI As described in the embodiments above, ToA measurements may be taken by the base station of the first wireless reference signal and the second wireless reference signal to determine this time difference. Similar to the functionality at block 1110, “obtaining” may be performed differently, depending on which device is performing the functionality at block 1120. As illustrated in the examples of FIGS. 7-9, the second time difference may be obtained by the base station using ToA measurements, as described. If the functionality at block 1120 is performed by the location server or the first mobile device, for example, the second time difference can be obtained by receiving information of the second time difference from the base station.

Means for performing functionality at block 1120 may comprise a bus 1205, wireless communication interface 1230, digital signal processor (DSP) 1220, processing unit(s) 1210, memory 1260, and/or other components of a mobile device, as illustrated in FIG. 12. Additionally or alternatively, means for performing functionality at block 1120 may comprise a bus 1305, wireless communication interface 1330, DSP 1320, processing unit(s) 1310, memory 1360, and/or other components of a base station, as illustrated in FIG. 13. Additionally or alternatively, means for performing functionality at block 1120 may comprise a bus 1405, communications subsystem 1430, processing unit(s) 1410, working memory 1435, and/or other components of a computer, as illustrated in FIG. 14.

At block 1130, the functionality comprises determining the position of the first mobile device based on the first time difference and the second time difference. This can be done, for example, using equations (1)-(3) described herein. This determination may be based on the locations of the base station and second mobile device. As such, according to some embodiments, the method 1100 may further comprise obtaining a position of the base station and a position of the second mobile device, wherein determining the position of the first mobile device is further based on the position of the base station and the position of the second mobile device. As described in the embodiments above, a relative position the second device from the base station can be determined based on angle and distance from the base station. Accordingly, angle ϕ₂-ϕ₁ can be determined from the AoA measurements and distance R_{T} can be calculated in the manner above to determine a position of the first mobile device relative to the base station. As such, according to some embodiments, the method 1100 may further comprise determining a difference between an AoA of the first wireless reference signal at the base station and an AoA of the second wireless reference signal at the base station, wherein determining the position of the first mobile device is further based on the AoA.

As noted, and AoA may not necessarily be needed for determination of the position of the first mobile device. As indicated in FIG. 10, for example, the position of the first mobile device (the target UE 510) can be determined based on multi-lateration. Multi-lateration may be performed by calculating Rₛᵤₘ for the second mobile device and one or more additional mobile devices. As such, according to some embodiments, the method 1100 may further comprise determining the position of the first mobile device comprises using multilateration to determine the position of the first mobile device based on (i) distances of the first mobile device from the base station and the second mobile device determined using the first time difference and the second time difference, and (ii) distances of the first mobile device from the base station and a plurality of additional mobile devices determined from wireless reference signals transmitted by the additional mobile devices and one or more wireless reference signals transmitted by the first mobile device.

Means for performing functionality at block 1130 may comprise a bus 1205, digital signal processor (DSP) 1220, processing unit(s) 1210, memory 1260, and/or other components of a mobile device, as illustrated in FIG. 12. Additionally or alternatively, means for performing functionality at block 1130 may comprise a bus 1305, DSP 1320, processing unit(s) 1310, memory 1360, and/or other components of a base station, as illustrated in FIG. 13. Additionally or alternatively, means for performing functionality at block 1130 may comprise a bus 1405, processing unit(s) 1410, working memory 1435, and/or other components of a computer, as illustrated in FIG. 14.

The functionality of block 1140 comprises providing the position of the first mobile device. As previously indicated, providing the position of the first mobile device may vary, depending on the device performing the functionality of block 1140 and/or the entire method 1100. For example, according to some embodiments, the position of the first mobile device is determined by the first mobile device. In such embodiments, obtaining the first time difference may comprise measuring the first time difference at the first mobile device, obtaining the second time difference may comprise receiving the second time difference at the first mobile device from the base station, and providing the position of the first mobile device may comprise providing information indicative of the position of the first mobile device to a user interface of the first mobile device, to an application executed by the first mobile device, or both. Alternatively, for embodiments in which the position of the first mobile device is determined by the location server, obtaining the first time difference may comprise receiving the first time difference at the location server from the first mobile device, obtaining the second time difference may comprise receiving the second time difference at the location server from the base station, and providing the position of the first mobile device may comprise sending information indicative of the position of the first mobile device from the location server to a requesting entity. In such embodiments, the method 1100 may further comprise receiving, at the location server, a request for the position of the first mobile device from the requesting entity prior to obtaining the first time difference or the second time difference. Alternatively, for embodiments in which the position of the first mobile device is determined by the base station, obtaining the first time difference may comprise receiving the first time difference at the base station from the first mobile device, obtaining the second time difference may comprise measuring the second time difference with the base station, and providing the position of the first mobile device may comprise sending information indicative of the position of the first mobile device to the first mobile device or a location server.

Some embodiments of the method 1100 may further comprise configuring the first mobile device and/or second mobile device to perform the CLI-aided positioning as described herein. For example, according to some embodiments, the method 1100 may further comprise sending a first configuration to the first mobile device, wherein the first configuration configures the first mobile device to receive the DL transmissions, and sending a second configuration to the second mobile device, wherein the second configuration configures the second mobile device to transmit the first wireless reference signal such that the first wireless reference signal arrives at the first mobile device at the time during which the first mobile device is configured to receive the downlink DL transmissions. In such embodiments, sending the first configuration, sending the second configuration, or both, is performed by a location server or the base station. It can be noted that the configuration of the second mobile device may not necessarily be a configuration for positioning of the first mobile device. As indicated elsewhere herein the second mobile device may transmit the first wireless reference signal in accordance with non-positioning functionality (data transmission, communication, etc.). In such instances, the second configuration may be made to perform the non-positioning functionality. Further, in such instances, the first configuration of the first mobile device may be based, at least in part, on the second configuration, to help ensure the first mobile device measures the first wireless reference signal.

As noted in the previously-described embodiments, the determination of the position of the first mobile device may be based on different data (e.g., multi-lateration versus distance and angle from base station). Thus, according to some embodiments of the method 1100, determining the position of the first mobile device may comprise using multilateration to determine the position of the first mobile device based on (i) distances of the first mobile device from the base station and the second mobile device determined using the first time difference and the second time difference, and (ii) distances of the first mobile device from the base station and a plurality of additional mobile devices determined from wireless reference signals transmitted by the additional mobile devices and one or more wireless reference signals transmitted by the first mobile device.

Means for performing functionality at block 1140 may comprise a bus 1205, wireless communication interface 1230, digital signal processor (DSP) 1220, processing unit(s) 1210, memory 1260, and/or other components of a mobile device, as illustrated in FIG. 12. Additionally or alternatively, means for performing functionality at block 1140 may comprise a bus 1305, wireless communication interface 1330, DSP 1320, processing unit(s) 1310, memory 1360, and/or other components of a base station, as illustrated in FIG. 13. Additionally or alternatively, means for performing functionality at block 1140 may comprise a bus 1405, communications subsystem 1430, processing unit(s) 1410, working memory 1435, and/or other components of a computer, as illustrated in FIG. 14.

FIG. 12 illustrates an embodiment of a mobile device 1200, which can be utilized as described herein above (e.g., in association with FIGS. 1-11) with regard to mobile devices and/or UEs, such as the UE 105, UEs 145, target UE 510, and/or anchor UE 520. Moreover, the mobile device 1200 may correspond with the first and/or second mobile device described in relation to FIG. 11. As such, the mobile device 1200 can perform one or more of the functions of the method shown in FIG. 11. It should be noted that FIG. 12 is meant only to provide a generalized illustration of various components, any or all of which may be utilized as appropriate. It can be noted that, in some instances, components illustrated by FIG. 12 can be localized to a single physical device and/or distributed among various networked devices, which may be disposed at different physical locations (e.g., different physical locations on a vehicle). Furthermore, as previously noted, the functionality of the UE discussed in the previously described embodiments may be executed by one or more of the hardware and/or software components illustrated in FIG. 12.

The mobile device 1200 is shown comprising hardware elements that can be electrically coupled via a bus 1205 (or may otherwise be in communication, as appropriate). The hardware elements may include a processing unit(s) 1210 which can include without limitation one or more general-purpose processors, one or more special-purpose processors (such as DSP chips, graphics acceleration processors, application specific integrated circuits (ASICs), and/or the like), and/or other processing structures or means. As shown in FIG. 12, some embodiments may have a separate DSP 1220, depending on desired functionality. Location determination and/or other determinations based on wireless communication may be provided in the processing unit(s) 1210 and/or wireless communication interface 1230 (discussed below). The mobile device 1200 also can include one or more input devices 1270, which can include without limitation one or more keyboards, touch screens, touch pads, microphones, buttons, dials, switches, and/or the like; and one or more output devices 1215, which can include without limitation one or more displays (e.g., touch screens), light emitting diodes (LEDs), speakers, and/or the like.

The mobile device 1200 may also include a wireless communication interface 1230, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile device 1200 to communicate with other devices as described in the embodiments above. The wireless communication interface 1230 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1232 that send and/or receive wireless signals 1234. According to some embodiments, the wireless communication antenna(s) 1232 may comprise a plurality of discrete antennas, antenna arrays, or any combination thereof. The antenna(s) 1232 may be capable of transmitting and receiving wireless signals using beams (e.g., Tx beams and Rx beams). Beam formation may be performed using digital and/or analog beam formation techniques, with respective digital and/or analog circuitry. The wireless communication interface 1230 may include such circuitry.

Depending on desired functionality, the wireless communication interface 1230 may comprise a separate receiver and transmitter, or any combination of transceivers, transmitters, and/or receivers to communicate with base stations (e.g., ng-eNBs and gNBs) and other terrestrial transceivers, such as wireless devices and access points. The mobile device 1200 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000, WCDMA, and so on. CDMA2000 includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. Cdma2000 is described in documents from a consortium named “3rd Generation Partnership Project 3” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 1200 can further include sensor(s) 1240. Sensor(s) 1240 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the mobile device 1200 may also include a Global Navigation Satellite System (GNSS) receiver 1280 capable of receiving signals 1284 from one or more GNSS satellites using an antenna 1282 (which could be the same as antenna 1232). Positioning based on GNSS signal measurement can be utilized to complement and/or incorporate the techniques described herein. The GNSS receiver 1280 can extract a position of the mobile device 1200, using conventional techniques, from GNSS satellites 110 of a GNSS system, such as Global Positioning System (GPS), Galileo, GLONASS, Quasi-Zenith Satellite System (QZSS) over Japan, Indian Regional Navigational Satellite System (IRNSS) over India, BeiDou Navigation Satellite System (BDS) over China, and/or the like. Moreover, the GNSS receiver 1280 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1280 is illustrated in FIG. 12 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processing units, such as processing unit(s) 1210, DSP 1220, and/or a processing unit within the wireless communication interface 1230 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processing units, such as processing unit(s) 1210 or DSP 1220.

The mobile device 1200 may further include and/or be in communication with a memory 1260. The memory 1260 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1260 of the mobile device 1200 also can comprise software elements (not shown in FIG. 12), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1260 that are executable by the mobile device 1200 (and/or processing unit(s) 1210 or DSP 1220 within mobile device 1200). In an aspect, then such code and/or instructions can be used to configure and/or adapt a general-purpose computer (or other device) to perform one or more operations in accordance with the described methods.

FIG. 13 illustrates an embodiment of a base station 1300, which can be utilized as described herein above (e.g., in association with FIGS. 1-12) with regard to base station 120, gNB 210, ng-eNB 214, and/or other types of base stations or TRPs. It should be noted that FIG. 13 is meant only to provide a generalized illustration of various components, any or all of which may be utilized as appropriate.

The base station 120 is shown comprising hardware elements that can be electrically coupled via a bus 1305 (or may otherwise be in communication, as appropriate). The hardware elements may include a processing unit(s) 1310 which can include without limitation one or more general-purpose processors, one or more special-purpose processors (such as DSP chips, graphics acceleration processors, ASICs, and/or the like), and/or other processing structure or means. As shown in FIG. 13, some embodiments may have a separate DSP 1320, depending on desired functionality. Location determination and/or other determinations based on wireless communication may be provided in the processing unit(s) 1310 and/or wireless communication interface 1330 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1330, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1330 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1332 that send and/or receive wireless signals 1334.

The base station 120 may also include a network interface 1380, which can include support of wireline communication technologies. The network interface 1380 may include a modem, network card, chipset, and/or the like. The network interface 1380 may include one or more input and/or output communication interfaces to permit data to be exchanged with a network, communication network servers, computer systems, and/or any other electronic devices described herein.

In many embodiments, the base station 120 may further comprise a memory 1360. The memory 1360 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1360 of the base station 120 also may comprise software elements (not shown in FIG. 13), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1360 that are executable by the base station 120 (and/or processing unit(s) 1310 or DSP 1320 within base station 120). In an aspect, then such code and/or instructions can be used to configure and/or adapt a general-purpose computer (or other device) to perform one or more operations in accordance with the described methods.

FIG. 14 is a block diagram of an embodiment of a computer system 1400, which may be used, in whole or in part, to provide the functions of one or more network components as described in the embodiments herein (e.g., location server 160, LMF 220, etc.). It should be noted that FIG. 14 is meant only to provide a generalized illustration of various components, any or all of which may be utilized as appropriate. FIG. 14, therefore, broadly illustrates how individual system elements may be implemented in a relatively separated or relatively more integrated manner. In addition, it can be noted that components illustrated by FIG. 14 can be localized to a single device and/or distributed among various networked devices, which may be disposed at different geographical locations.

The computer system 1400 is shown comprising hardware elements that can be electrically coupled via a bus 1405 (or may otherwise be in communication, as appropriate). The hardware elements may include processing unit(s) 1410, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 1400 also may comprise one or more input devices 1415, which may comprise without limitation a mouse, a keyboard, a camera, a microphone, and/or the like; and one or more output devices 1420, which may comprise without limitation a display device, a printer, and/or the like.

The computer system 1400 may further include (and/or be in communication with) one or more non-transitory storage devices 1425, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 1400 may also include a communications subsystem 1430, which may comprise wireless communication technologies managed and controlled by a wireless communication interface 1433, as well as wired technologies (such as Ethernet, coaxial communications, universal serial bus (USB), and the like). The wireless communication interface 1433 may send and receive wireless signals 1455 (e.g., signals according to 5G NR or LTE) via wireless antenna(s) 1450. Thus the communications subsystem 1430 may comprise a modem, a network card (wireless or wired), an infrared communication device, a wireless communication device, and/or a chipset, and/or the like, which may enable the computer system 1400 to communicate on any or all of the communication networks described herein to any device on the respective network, including a User Equipment (UE), base stations and/or other TRPs, and/or any other electronic devices described herein. Hence, the communications subsystem 1430 may be used to receive and send data as described in the embodiments herein.

In many embodiments, the computer system 1400 will further comprise a working memory 1435, which may comprise a RAM or ROM device, as described above. Software elements, shown as being located within the working memory 1435, may comprise an operating system 1440, device drivers, executable libraries, and/or other code, such as one or more applications 1445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processing unit within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 1425 described above. In some cases, the storage medium might be incorporated within a computer system, such as computer system 1400. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 1400 and/or might take the form of source and/or installable code, which, upon compilation and/or installation on the computer system 1400 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

In view of this description embodiments may include different combinations of features. Implementation examples are described in the following numbered clauses:
Clause 1. A method of determining a position of a first mobile device, the method comprising: obtaining a first time difference, wherein the first time difference comprises a time difference between: a time a first wireless reference signal transmitted by a second mobile device arrives at the first mobile device; and a time the first mobile device transmits a second wireless reference signal, wherein: the first mobile device and the second mobile device are communicatively linked to a wireless communication network employing time-division duplexing (TDD), and the first wireless reference signal comprises a cross-link interference (CLI) transmission, such that the first wireless reference signal arrives at the first mobile device at a time during which the first mobile device is configured to receive downlink (DL) transmissions from a network entity; obtaining a second time difference, wherein the second time difference comprises a time difference between: a time the first wireless reference signal arrives at a base station of the wireless communication network, and a time the second wireless reference signal arrives at the base station; determining the position of the first mobile device based on the first time difference and the second time difference; and providing the position of the first mobile device.
Clause 2. The method of clause 1, further comprising obtaining a position of the base station and a position of the second mobile device, wherein determining the position of the first mobile device is further based on the position of the base station and the position of the second mobile device.
Clause 3. The method of any of clauses 1-2 further comprising sending a first configuration to the first mobile device, wherein the first configuration configures the first mobile device to receive the DL transmissions, and sending a second configuration to the second mobile device, wherein the second configuration configures the second mobile device to transmit the first wireless reference signal such that the first wireless reference signal arrives at the first mobile device at the time during which the first mobile device is configured to receive the downlink DL transmissions.
Clause 4. The method of clause 3 wherein sending the first configuration, sending the second configuration, or both, is performed by a location server or the base station.
Clause 5. The method of any of clauses 1-4 wherein the position of the first mobile device is determined by the base station, and wherein: obtaining the first time difference comprises receiving the first time difference at the base station from the first mobile device; obtaining the second time difference comprises measuring the second time difference with the base station; and providing the position of the first mobile device comprises sending information indicative of the position of the first mobile device to the first mobile device or a location server.
Clause 6. The method of any of clauses 1-4 wherein the position of the first mobile device is determined by a location server, and wherein: obtaining the first time difference comprises receiving the first time difference at the location server from the first mobile device; obtaining the second time difference comprises receiving the second time difference at the location server from the base station; and providing the position of the first mobile device comprises sending information indicative of the position of the first mobile device from the location server to a requesting entity.
Clause 7. The method of clause 6 further comprising receiving, at the location server, a request for the position of the first mobile device from the requesting entity prior to obtaining the first time difference or the second time difference.
Clause 8. The method of any of clauses 1-4 wherein the position of the first mobile device is determined by the first mobile device, and wherein: obtaining the first time difference comprises measuring the first time difference at the first mobile device; obtaining the second time difference comprises receiving the second time difference at the first mobile device from the base station; and providing the position of the first mobile device comprises providing information indicative of the position of the first mobile device via a user interface of the first mobile device, to an application executed by the first mobile device, or both.
Clause 9. The method of any of clauses 1-8 wherein the first wireless reference signal comprises a Sounding Reference Signal (SRS).
Clause 10. The method of any of clauses 1-9 wherein the second wireless reference signal comprises an uplink (UL) transmission comprising: a Physical Uplink Control Channel (PUCCH), a Physical Uplink Shared Channel (PUSCH), a Physical Random Access Channel (PRACH) preamble, or an SRS, or a combination thereof.
Clause 11. The method of any of clauses 1-10 further comprising determining a difference between an Angle of Arrival (AoA) of the first wireless reference signal at the base station and an AoA of the second wireless reference signal at the base station, wherein determining the position of the first mobile device is further based on the AoA.
Clause 12. The method of any of clauses 1-10 wherein determining the position of the first mobile device comprises using multilateration to determine the position of the first mobile device based on: distances of the first mobile device from the base station and the second mobile device determined using the first time difference and the second time difference; and distances of the first mobile device from the base station and a plurality of additional mobile devices determined from wireless reference signals transmitted by the additional mobile devices and one or more wireless reference signals transmitted by the first mobile device.
Clause 13. The method of any of clauses 1-12 wherein the one or more wireless reference signals transmitted by the first mobile device comprises the second wireless reference signal.
Clause 14. A network-connected device for determining a position of a first mobile device, the network-connected device comprising: a transceiver; a memory; and one or more processors communicatively coupled with the transceiver and the memory, wherein the one or more processors are configured to: obtain a first time difference, wherein the first time difference comprises a time difference between: a time a first wireless reference signal transmitted by a second mobile device arrives at the first mobile device; and a time the first mobile device transmits a second wireless reference signal, wherein: the first mobile device and the second mobile device are communicatively linked to a wireless communication network employing time-division duplexing (TDD), and the first wireless reference signal comprises a cross-link interference (CLI) transmission, such that the first wireless reference signal arrives at the first mobile device at a time during which the first mobile device is configured to receive downlink (DL) transmissions from a network entity; obtain a second time difference, wherein the second time difference comprises a time difference between: a time the first wireless reference signal arrives at a base station of the wireless communication network, and a time the second wireless reference signal arrives at the base station; determine the position of the first mobile device based on the first time difference and the second time difference; and provide the position of the first mobile device.
Clause 15. The network-connected device of clause 14, wherein the one or more processors are further configured to obtain a position of the base station and a position of the second mobile device, wherein the one or more processors are configured to determine the position of the first mobile device further based on the position of the base station and the position of the second mobile device.
Clause 16. The network-connected device of any of clauses 14-15 wherein the one or more processors are further configured to: send a first configuration to the first mobile device, wherein the first configuration configures the first mobile device to receive the DL transmissions, and send a second configuration to the second mobile device, wherein the second configuration configures the second mobile device to transmit the first wireless reference signal such that the first wireless reference signal arrives at the first mobile device at the time during which the first mobile device is configured to receive the downlink DL transmissions.
Clause 17. The network-connected device of clause 16 wherein sending the first configuration, sending the second configuration, or both, is performed by a location server or the base station.
Clause 18. The network-connected device of any of clauses 14-17 wherein the position of the first mobile device is determined by the base station, and wherein: obtain the first time difference comprises receiving the first time difference at the base station from the first mobile device; obtain the second time difference comprises measuring the second time difference with the base station; and provide the position of the first mobile device comprises sending information indicative of the position of the first mobile device to the first mobile device or a location server.
Clause 19. The network-connected device of any of clauses 14-17 wherein the position of the first mobile device is determined by a location server, and wherein: obtain the first time difference comprises receiving the first time difference at the location server from the first mobile device; obtain the second time difference comprises receiving the second time difference at the location server from the base station; and provide the position of the first mobile device comprises sending information indicative of the position of the first mobile device from the location server to a requesting entity.
Clause 20. The network-connected device of clause 19 wherein the one or more processors are further configured to receive, at the location server, a request for the position of the first mobile device from the requesting entity prior to obtaining the first time difference or the second time difference.
Clause 21. The network-connected device of any of clauses 14-17 wherein the position of the first mobile device is determined by the first mobile device, and wherein: obtain the first time difference comprises measuring the first time difference at the first mobile device; obtain the second time difference comprises receiving the second time difference at the first mobile device from the base station; and provide the position of the first mobile device comprises providing information indicative of the position of the first mobile device via a user interface of the first mobile device, to an application executed by the first mobile device, or both.
Clause 22. The network-connected device of any of clauses 14-21 wherein the first wireless reference signal comprises a Sounding Reference Signal (SRS).
Clause 23. The network-connected device of any of clauses 14-22 wherein the second wireless reference signal comprises an uplink (UL) transmission comprising: a Physical Uplink Control Channel (PUCCH), a Physical Uplink Shared Channel (PUSCH), a Physical Random Access Channel (PRACH) preamble, or an SRS, or a combination thereof.
Clause 24. The network-connected device of any of clauses 14-23 wherein the one or more processors are further configured to determine a difference between an Angle of Arrival (AoA) of the first wireless reference signal at the base station and an AoA of the second wireless reference signal at the base station, wherein determining the position of the first mobile device is further based on the AoA.
Clause 25. The network-connected device of any of clauses 14-23 wherein the one or more processors, to determine the position of the first mobile device, are configured to use multilateration to determine the position of the first mobile device based on: distances of the first mobile device from the base station and the second mobile device determined using the first time difference and the second time difference; and distances of the first mobile device from the base station and a plurality of additional mobile devices determined from wireless reference signals transmitted by the additional mobile devices and one or more wireless reference signals transmitted by the first mobile device.
Clause 26. The network-connected device of any of clauses 14-25 wherein the one or more wireless reference signals transmitted by the first mobile device comprises the second wireless reference signal.
Clause 27. An apparatus for determining a position of a first mobile device, the apparatus comprising: means for obtaining a first time difference, wherein the first time difference comprises a time difference between: a time a first wireless reference signal transmitted by a second mobile device arrives at the first mobile device; and a time the first mobile device transmits a second wireless reference signal, wherein: the first mobile device and the second mobile device are communicatively linked to a wireless communication network employing time-division duplexing (TDD), and the first wireless reference signal comprises a cross-link interference (CLI) transmission, such that the first wireless reference signal arrives at the first mobile device at a time during which the first mobile device is configured to receive downlink (DL) transmissions from a network entity; means for obtaining a second time difference, wherein the second time difference comprises a time difference between: a time the first wireless reference signal arrives at a base station of the wireless communication network, and a time the second wireless reference signal arrives at the base station; means for determining the position of the first mobile device based on the first time difference and the second time difference; and means for providing the position of the first mobile device.
Clause 28. The apparatus of clause 27, further comprising means for obtaining a position of the base station and a position of the second mobile device, wherein means for determining the position of the first mobile device is further based on the position of the base station and the position of the second mobile device.
Clause 29. The apparatus of any of clauses 27-28 further comprising means for sending a first configuration to the first mobile device, wherein the first configuration configures the first mobile device to receive the DL transmissions, and means for sending a second configuration to the second mobile device, wherein the second configuration configures the second mobile device to transmit the first wireless reference signal such that the first wireless reference signal arrives at the first mobile device at the time during which the first mobile device is configured to receive the downlink DL transmissions.
Clause 30. The apparatus of clause 29 wherein sending the first configuration, sending the second configuration, or both, is performed by a location server or the base station.
Clause 31. The apparatus of any of clauses 27-30 wherein the position of the first mobile device is determined by the base station, and wherein: means for obtaining the first time difference comprises receiving the first time difference at the base station from the first mobile device; means for obtaining the second time difference comprises measuring the second time difference with the base station; and means for providing the position of the first mobile device comprises sending information indicative of the position of the first mobile device to the first mobile device or a location server.
Clause 32. The apparatus of any of clauses 27-30 wherein the position of the first mobile device is determined by a location server, and wherein: means for obtaining the first time difference comprises receiving the first time difference at the location server from the first mobile device; means for obtaining the second time difference comprises receiving the second time difference at the location server from the base station; and means for providing the position of the first mobile device comprises sending information indicative of the position of the first mobile device from the location server to a requesting entity.
Clause 33. The apparatus of clause 32 further comprising means for receiving, at the location server, a request for the position of the first mobile device from the requesting entity prior to obtaining the first time difference or the second time difference.
Clause 34. The apparatus of any of clauses 27-30 wherein the position of the first mobile device is determined by the first mobile device, and wherein: means for obtaining the first time difference comprises measuring the first time difference at the first mobile device; means for obtaining the second time difference comprises receiving the second time difference at the first mobile device from the base station; and means for providing the position of the first mobile device comprises providing information indicative of the position of the first mobile device via a user interface of the first mobile device, an application executed by the first mobile device, or both.
Clause 35. The apparatus of any of clauses 27-34 wherein the first wireless reference signal comprises a Sounding Reference Signal (SRS).
Clause 36. The apparatus of any of clauses 27-35 wherein the second wireless reference signal comprises an uplink (UL) transmission comprising: a Physical Uplink Control Channel (PUCCH), a Physical Uplink Shared Channel (PUSCH), a Physical Random Access Channel (PRACH) preamble, or an SRS, or a combination thereof.
Clause 37. The apparatus of any of clauses 27-36 further comprising means for determining a difference between an Angle of Arrival (AoA) of the first wireless reference signal at the base station and an AoA of the second wireless reference signal at the base station, wherein determining the position of the first mobile device is further based on the AoA.
Clause 38. The apparatus of any of clauses 27-36 wherein the means for determining the position of the first mobile device comprises means for using multilateration to determine the position of the first mobile device based on: distances of the first mobile device from the base station and the second mobile device determined using the first time difference and the second time difference; and distances of the first mobile device from the base station and a plurality of additional mobile devices determined from wireless reference signals transmitted by the additional mobile devices and one or more wireless reference signals transmitted by the first mobile device.
Clause 39. The apparatus of any of clauses 27-38 wherein the one or more wireless reference signals transmitted by the first mobile device comprises the second wireless reference signal.
Clause 40. A non-transitory computer-readable medium storing instructions for determining a position of a first mobile device, the instructions comprising code for: obtaining a first time difference, wherein the first time difference comprises a time difference between: a time a first wireless reference signal transmitted by a second mobile device arrives at the first mobile device; and a time the first mobile device transmits a second wireless reference signal, wherein: the first mobile device and the second mobile device are communicatively linked to a wireless communication network employing time-division duplexing (TDD), and the first wireless reference signal comprises a cross-link interference (CLI) transmission, such that the first wireless reference signal arrives at the first mobile device at a time during which the first mobile device is configured to receive downlink (DL) transmissions from a network entity; obtaining a second time difference, wherein the second time difference comprises a time difference between: a time the first wireless reference signal arrives at a base station of the wireless communication network, and a time the second wireless reference signal arrives at the base station; determining the position of the first mobile device based on the first time difference and the second time difference; and providing the position of the first mobile device.
Clause 41. The computer-readable medium of clause 40, further comprising obtaining a position of the base station and a position of the second mobile device, wherein determining the position of the first mobile device is further based on the position of the base station and the position of the second mobile device.
Clause 42. The computer-readable medium of any of clauses 40-41 further comprising sending a first configuration to the first mobile device, wherein the first configuration configures the first mobile device to receive the DL transmissions, and sending a second configuration to the second mobile device, wherein the second configuration configures the second mobile device to transmit the first wireless reference signal such that the first wireless reference signal arrives at the first mobile device at the time during which the first mobile device is configured to receive the downlink DL transmissions.
Clause 43. The computer-readable medium of clause 42 wherein sending the first configuration, sending the second configuration, or both, is performed by a location server or the base station.
Clause 44. The computer-readable medium of any of clauses 40-43 wherein the position of the first mobile device is determined by the base station, and wherein: obtaining the first time difference comprises receiving the first time difference at the base station from the first mobile device; obtaining the second time difference comprises measuring the second time difference with the base station; and providing the position of the first mobile device comprises sending information indicative of the position of the first mobile device to the first mobile device or a location server.
Clause 45. The computer-readable medium of any of clauses 40-43 wherein the position of the first mobile device is determined by a location server, and wherein: obtaining the first time difference comprises receiving the first time difference at the location server from the first mobile device; obtaining the second time difference comprises receiving the second time difference at the location server from the base station; and providing the position of the first mobile device comprises sending information indicative of the position of the first mobile device from the location server to a requesting entity.
Clause 46. The computer-readable medium of clause 45 further comprising receiving, at the location server, a request for the position of the first mobile device from the requesting entity prior to obtaining the first time difference or the second time difference.
Clause 47. The computer-readable medium of any of clauses 40-43 wherein the position of the first mobile device is determined by the first mobile device, and wherein: obtaining the first time difference comprises measuring the first time difference at the first mobile device; obtaining the second time difference comprises receiving the second time difference at the first mobile device from the base station; and providing the position of the first mobile device comprises providing information indicative of the position of the first mobile device to a user of the first mobile device, an application executed by the first mobile device, or both.
Clause 48. The computer-readable medium of any of clauses 40-47 wherein the first wireless reference signal comprises a Sounding Reference Signal (SRS).
Clause 49. The computer-readable medium of any of clauses 40-48 wherein the second wireless reference signal comprises an uplink (UL) transmission comprising: a Physical Uplink Control Channel (PUCCH), a Physical Uplink Shared Channel (PUSCH), a Physical Random Access Channel (PRACH) preamble, or an SRS, or a combination thereof.
Clause 50. The computer-readable medium of any of clauses 40-49 further comprising determining a difference between an Angle of Arrival (AoA) of the first wireless reference signal at the base station and an AoA of the second wireless reference signal at the base station, wherein determining the position of the first mobile device is further based on the AoA.
Clause 51. The computer-readable medium of any of clauses 40-49 wherein determining the position of the first mobile device comprises using multilateration to determine the position of the first mobile device based on: distances of the first mobile device from the base station and the second mobile device determined using the first time difference and the second time difference; and distances of the first mobile device from the base station and a plurality of additional mobile devices determined from wireless reference signals transmitted by the additional mobile devices and one or more wireless reference signals transmitted by the first mobile device.
Clause 52. The computer-readable medium of any of clauses 40-51 wherein the one or more wireless reference signals transmitted by the first mobile device comprises the second wireless reference signal.

What is claimed is:

1. A method of determining a position of a first mobile device, the method comprising:
obtaining a first time difference, wherein the first time difference comprises a time difference between:
a time a first wireless reference signal transmitted by a second mobile device arrives at the first mobile device; and
a time the first mobile device transmits a second wireless reference signal, wherein:
the first mobile device and the second mobile device are communicatively linked to a wireless communication network employing time-division duplexing (TDD), and
the first wireless reference signal comprises a cross-link interference (CLI) transmission, such that the first wireless reference signal arrives at the first mobile device at a time during which the first mobile device is configured to receive downlink (DL) transmissions from a network entity;
obtaining a second time difference, wherein the second time difference comprises a time difference between:
a time the first wireless reference signal arrives at a base station of the wireless communication network, and
a time the second wireless reference signal arrives at the base station;
determining the position of the first mobile device based on the first time difference and the second time difference; and
providing the position of the first mobile device.

2. The method of claim 1, further comprising obtaining a position of the base station and a position of the second mobile device, wherein determining the position of the first mobile device is further based on the position of the base station and the position of the second mobile device.

3. The method of claim 1, further comprising:
sending a first configuration to the first mobile device, wherein the first configuration configures the first mobile device to receive the DL transmissions, and
sending a second configuration to the second mobile device, wherein the second configuration configures the second mobile device to transmit the first wireless reference signal such that the first wireless reference signal arrives at the first mobile device at the time during which the first mobile device is configured to receive the downlink DL transmissions.

4. The method of claim 3, wherein sending the first configuration, sending the second configuration, or both, is performed by a location server or the base station.

5. The method of claim 1, wherein the position of the first mobile device is determined by the base station, and wherein:
obtaining the first time difference comprises receiving the first time difference at the base station from the first mobile device;
obtaining the second time difference comprises measuring the second time difference by the base station; and
providing the position of the first mobile device comprises sending information indicative of the position of the first mobile device to the first mobile device or a location server.

6. The method of claim 1, wherein the position of the first mobile device is determined by a location server, and wherein:
obtaining the first time difference comprises receiving the first time difference at the location server from the first mobile device;
obtaining the second time difference comprises receiving the second time difference at the location server from the base station; and
providing the position of the first mobile device comprises sending information indicative of the position of the first mobile device from the location server to a requesting entity.

7. The method of claim 6, further comprising receiving, at the location server, a request for the position of the first mobile device from the requesting entity prior to obtaining the first time difference or the second time difference.

8. The method of claim 1, wherein the position of the first mobile device is determined by the first mobile device, and wherein:
obtaining the first time difference comprises measuring the first time difference at the first mobile device;
obtaining the second time difference comprises receiving the second time difference at the first mobile device from the base station; and
providing the position of the first mobile device comprises providing information indicative of the position of the first mobile device via a user interface of the first mobile device, to an application executed by the first mobile device, or both.

9. The method of claim 1, wherein the first wireless reference signal comprises a Sounding Reference Signal (SRS).

10. The method of claim 1, wherein the second wireless reference signal comprises an uplink (UL) transmission comprising:
a Physical Uplink Control Channel (PUCCH),
a Physical Uplink Shared Channel (PUSCH),
a Physical Random Access Channel (PRACH) preamble, or
an SRS, or
a combination thereof.

11. The method of claim 1, further comprising determining a difference between an Angle of Arrival (AoA) of the first wireless reference signal at the base station and an AoA of the second wireless reference signal at the base station, wherein determining the position of the first mobile device is further based on the AoA.

12. The method of claim 1, wherein determining the position of the first mobile device comprises using multilateration to determine the position of the first mobile device based on:
distances of the first mobile device from the base station and the second mobile device determined using the first time difference and the second time difference; and
distances of the first mobile device from the base station and a plurality of additional mobile devices determined from wireless reference signals transmitted by the additional mobile devices and one or more wireless reference signals transmitted by the first mobile device.

13. The method of claim 12, wherein the one or more wireless reference signals transmitted by the first mobile device comprises the second wireless reference signal.

14. A network-connected device for determining a position of a first mobile device, the network-connected device comprising:
a transceiver;
a memory; and
one or more processors communicatively coupled with the transceiver and the memory, wherein the one or more processors are configured to:
obtain a first time difference, wherein the first time difference comprises a time difference between:
a time a first wireless reference signal transmitted by a second mobile device arrives at the first mobile device; and
a time the first mobile device transmits a second wireless reference signal, wherein:
the first mobile device and the second mobile device are communicatively linked to a wireless communication network employing time-division duplexing (TDD), and
the first wireless reference signal comprises a cross-link interference (CLI) transmission, such that the first wireless reference signal arrives at the first mobile device at a time during which the first mobile device is configured to receive downlink (DL) transmissions from a network entity;
obtain a second time difference, wherein the second time difference comprises a time difference between:
a time the first wireless reference signal arrives at a base station of the wireless communication network, and
a time the second wireless reference signal arrives at the base station;
determine the position of the first mobile device based on the first time difference and the second time difference; and
provide the position of the first mobile device.

15. The network-connected device of claim 14, wherein the one or more processors are further configured to obtain a position of the base station and a position of the second mobile device, wherein the one or more processors are configured to determine the position of the first mobile device further based on the position of the base station and the position of the second mobile device.

16. The network-connected device of claim 14, wherein the one or more processors are further configured to:
send a first configuration to the first mobile device via the transceiver, wherein the first configuration configures the first mobile device to receive the DL transmissions, and
send a second configuration to the second mobile device via the transceiver, wherein the second configuration configures the second mobile device to transmit the first wireless reference signal such that the first wireless reference signal arrives at the first mobile device at the time during which the first mobile device is configured to receive the downlink DL transmissions.

17. The network-connected device of claim 14, wherein the network-connected device comprises the base station, and wherein:
to obtain the first time difference, the one or more processors are configured to receive the first time difference via the transceiver from the first mobile device;
to obtain the second time difference, the one or more processors are configured to measure the second time difference; and
to provide the position of the first mobile device, the one or more processors are configured to send information indicative of the position of the first mobile device to the first mobile device or a location server via the transceiver.

18. The network-connected device of claim 14, wherein the network-connected device comprises a location server, and wherein:
to obtain the first time difference, the one or more processors are configured to receive the first time difference from the first mobile device via the transceiver;
to obtain the second time difference, the one or more processors are configured to receive the second time difference from the base station via the transceiver; and
to provide the position of the first mobile device, the one or more processors are configured to send information indicative of the position of the first mobile device to a requesting entity via the transceiver.

19. The network-connected device of claim 18, wherein the one or more processors are further configured to receive, via the transceiver, a request for the position of the first mobile device from the requesting entity prior to obtaining the first time difference or the second time difference.

20. The network-connected device of claim 14, wherein the network-connected device comprises the first mobile device, and wherein:
to obtain the first time difference, the one or more processors are configured to measure the first time difference at the first mobile device;
to obtain the second time difference, the one or more processors are configured to receive the second time difference from the base station via the transceiver; and
to provide the position of the first mobile device, the one or more processors are configured to provide information indicative of the position of the first mobile device via a user interface of the first mobile device, to an application executed by the first mobile device, or both.

21. The network-connected device of claim 14, wherein the first wireless reference signal comprises a Sounding Reference Signal (SRS).

22. The network-connected device of claim 14, wherein the second wireless reference signal comprises an uplink (UL) transmission comprising:
a Physical Uplink Control Channel (PUCCH),
a Physical Uplink Shared Channel (PUSCH),
a Physical Random Access Channel (PRACH) preamble, or
an SRS, or
a combination thereof.

23. The network-connected device of claim 14, wherein the one or more processors are further configured to determine a difference between an Angle of Arrival (AoA) of the first wireless reference signal at the base station and an AoA of the second wireless reference signal at the base station, wherein determining the position of the first mobile device is further based on the AoA.

24. The network-connected device of claim 14, wherein the one or more processors, to determine the position of the first mobile device, are configured to use multilateration to determine the position of the first mobile device based on:
distances of the first mobile device from the base station and the second mobile device determined using the first time difference and the second time difference; and
distances of the first mobile device from the base station and a plurality of additional mobile devices determined from wireless reference signals transmitted by the additional mobile devices and one or more wireless reference signals transmitted by the first mobile device.

25. An apparatus for determining a position of a first mobile device, the apparatus comprising:
means for obtaining a first time difference, wherein the first time difference comprises a time difference between:
a time a first wireless reference signal transmitted by a second mobile device arrives at the first mobile device; and
a time the first mobile device transmits a second wireless reference signal, wherein:
the first mobile device and the second mobile device are communicatively linked to a wireless communication network employing time-division duplexing (TDD), and
the first wireless reference signal comprises a cross-link interference (CLI) transmission, such that the first wireless reference signal arrives at the first mobile device at a time during which the first mobile device is configured to receive downlink (DL) transmissions from a network entity;
means for obtaining a second time difference, wherein the second time difference comprises a time difference between:
a time the first wireless reference signal arrives at a base station of the wireless communication network, and
a time the second wireless reference signal arrives at the base station;
means for determining the position of the first mobile device based on the first time difference and the second time difference; and
means for providing the position of the first mobile device.

26. The apparatus of claim 25, further comprising means for obtaining a position of the base station and a position of the second mobile device, wherein means for determining the position of the first mobile device is further based on the position of the base station and the position of the second mobile device.

27. The apparatus of claim 25, further comprising:
means for sending a first configuration to the first mobile device, wherein the first configuration configures the first mobile device to receive the DL transmissions, and
means for sending a second configuration to the second mobile device, wherein the second configuration configures the second mobile device to transmit the first wireless reference signal such that the first wireless reference signal arrives at the first mobile device at the time during which the first mobile device is configured to receive the downlink DL transmissions.

28. The apparatus of claim 25, wherein the apparatus comprises the base station, and wherein:
the means for obtaining the first time difference comprises means for receiving the first time difference at the base station from the first mobile device;
the means for obtaining the second time difference comprises means for measuring the second time difference with the base station; and
the means for providing the position of the first mobile device comprises means for sending information indicative of the position of the first mobile device to the first mobile device or a location server.

29. The apparatus of claim 25, wherein the apparatus comprises a location server, and wherein:
the means for obtaining the first time difference comprises means for receiving the first time difference at the location server from the first mobile device;
the means for obtaining the second time difference comprises means for receiving the second time difference at the location server from the base station; and
the means for providing the position of the first mobile device comprises means for sending information indicative of the position of the first mobile device from the location server to a requesting entity.

30. The apparatus of claim 29, further comprising means for receiving a request for the position of the first mobile device from the requesting entity prior to obtaining the first time difference or the second time difference.

31. The apparatus of claim 25, wherein the apparatus comprises the first mobile device, and wherein:
the means for obtaining the first time difference comprises means for measuring the first time difference at the first mobile device;
the means for obtaining the second time difference comprises means for receiving the second time difference at the first mobile device from the base station; and
the means for providing the position of the first mobile device comprises means for providing information indicative of the position of the first mobile device via a user interface of the first mobile device, an application executed by the first mobile device, or both.

32. The apparatus of claim 25, wherein the first wireless reference signal comprises a Sounding Reference Signal (SRS).

33. The apparatus of claim 25, wherein the second wireless reference signal comprises an uplink (UL) transmission comprising:
a Physical Uplink Control Channel (PUCCH),
a Physical Uplink Shared Channel (PUSCH),
a Physical Random Access Channel (PRACH) preamble, or
an SRS, or
a combination thereof.

34. The apparatus of claim 25, further comprising means for determining a difference between an Angle of Arrival (AoA) of the first wireless reference signal at the base station and an AoA of the second wireless reference signal at the base station, wherein determining the position of the first mobile device is further based on the AoA.

35. The apparatus of claim 25, wherein the means for determining the position of the first mobile device comprises means for using multilateration to determine the position of the first mobile device based on:
distances of the first mobile device from the base station and the second mobile device determined using the first time difference and the second time difference; and
distances of the first mobile device from the base station and a plurality of additional mobile devices determined from wireless reference signals transmitted by the additional mobile devices and one or more wireless reference signals transmitted by the first mobile device.

36. The apparatus of claim 35, wherein the one or more wireless reference signals transmitted by the first mobile device comprises the second wireless reference signal.

37. A non-transitory computer-readable medium storing instructions for determining a position of a first mobile device, the instructions comprising code for:
obtaining a first time difference, wherein the first time difference comprises a time difference between:
a time a first wireless reference signal transmitted by a second mobile device arrives at the first mobile device; and
a time the first mobile device transmits a second wireless reference signal, wherein:
the first mobile device and the second mobile device are communicatively linked to a wireless communication network employing time-division duplexing (TDD), and
the first wireless reference signal comprises a cross-link interference (CLI) transmission, such that the first wireless reference signal arrives at the first mobile device at a time during which the first mobile device is configured to receive downlink (DL) transmissions from a network entity;
obtaining a second time difference, wherein the second time difference comprises a time difference between:
a time the first wireless reference signal arrives at a base station of the wireless communication network, and
a time the second wireless reference signal arrives at the base station;
determining the position of the first mobile device based on the first time difference and the second time difference; and
providing the position of the first mobile device.
